(19) United States
(12) Patent Application Publication
(10) Pub. No.: US 2024/0083051 A1
(43) Pub. Date: Mar. 14, 2024

(54) RAZOR HEADS, KITS, RAZORS & METHODS COMPRISING THE SAME

(71) Applicant: BIC Violex Single Member S.A., Anoixi (GR)

(72) Inventors: Ioanna PREZA, Anoixi (GR); Dimitrios EFTHIMIADIS, Anoixi (GR); Efthymios SALTAS, Anoixi (GR); Panagiotis KOPELAS, Anoixi (GR)

(73) Assignee: BIC Violex Single Member S.A., Anoixi (GR)

(21) Appl. No.: 18/261,628

(22) PCT Filed: Dec. 14, 2021
(86) PCT No.: PCT/EP2021/085699

§ 371 Date: Jul. 14, 2023

(30) Foreign Application Priority Data
Jan. 15, 2021 (EP) 21151842.8

(51) Int. Cl. B26B 21/52; B26B 21/22; B26B 21/40

(52) U.S. Cl. CPC B26B 21/521; B26B 21/225; B26B 21/4031

(57) ABSTRACT

A razor head (10) comprises a frame (100) having a skin-contacting side (110) and a back side (120) opposite the skin-contacting side (110). A coupling section (200) is arranged on the back side (120), wherein the coupling section (200) is configured to couple the razor head (10) to a razor handle (30). The coupling section (200) comprises a first bearing mechanism (210) and a second bearing mechanism (220) that are functionally different.

### CROSS REFERENCE TO RELATED APPLICATIONS

This application claims priority from European patent application No. 21151842, filed on Jan. 15, 2021, the contents of which are hereby incorporated herein in their entirety by this reference.

### TECHNICAL FIELD

The present disclosure relates to the field of razors, more specifically to a razor head, a kit of parts comprising a plurality of razor heads, a razor comprising a razor head, and a method of assembling a razor.

### BACKGROUND

Razors (also known as safety razors) have a razor head that is permanently or removably attached to a razor handle which, in use, is oriented in shaving direction. Razor heads typically comprise one or more cutting members, each comprising a blade that is perpendicular to the shaving direction. Razor heads are also typically provided with a guard (at a leading longitudinal side of the razor head in the shaving direction) and a cap (at a trailing longitudinal side of the razor head in the shaving direction). In use, a user holds the razor handle in the shaving direction and brings the razor head into contact with a portion of skin defining a shaving plane.

In the field of razors, there are various razor models available on the market wherein the razor handles and/or razor heads differ in shape, features, aesthetics, color and/or material. On the one hand, there are razors having a razor head permanently attached to the razor handle, which may be disposed of when the razor blades are worn out. On the other hand, there are razors wherein the razor head is removably coupled to the razor handle such that, when the razor blades are worn out, the razor head can be decoupled, disposed of, and replaced by a new razor head. The state of the art discloses various connection mechanisms for such razors, including positively locking or non-positively connections. A razor head can also be coupled to a razor handle via a connecting adapter, which in turn is then coupled to the razor handle. Furthermore, there are razor heads that can be pivotally coupled to razor handles, either directly or via a connecting adapter to a razor handle, which can lead to improved shaving performance as the razor head may follow the contour of the skin. However, razor heads in the state of the art comprise different pivoting mechanisms such that a razor head can only be coupled to a specific type of razor handles or connecting adapters. More specifically, when a razor head is coupled to a razor handle or connecting adapter of a specific razor model, it may not be coupleable to a razor handle or connecting adapter of a different razor model. However, it would be desirable to be able to couple, more specifically to pivotally couple, a razor head with different razor handles and/or connecting adapters.

Thus, the object of the present disclosure is to provide a razor head which can be pivotally coupled to various razor handles or connecting adapters.

### SUMMARY

The present disclosure relates to a razor head as defined in claim 1, a kit of parts as defined in claim 13, a razor as defined in claim 14, and a method of assembling a razor as defined in claim 15. The dependent claims depict advantageous embodiments of the present disclosure.

According to a first aspect of the present disclosure, a razor head comprises a frame having a skin-contacting side and a back side opposite the skin-contacting side. A coupling section is arranged on the back side, wherein the coupling section is configured to couple the razor head to a razor handle. The coupling section comprises a first bearing mechanism and a second bearing mechanism that are functionally different. Due to the coupling section comprising the functionally different bearing mechanisms, different types of razor handles (e.g. disposable razor handles) can be coupled to the razor head. The razor head according to the present disclosure can lead to ergonomic and functional improvements.

At least one of the first and the second bearing mechanisms can be a pivoting mechanism. In embodiments, each of the first and second bearing mechanisms can be a pivoting mechanism. Thus, the bearing mechanisms can support two kinds of pivoting mechanisms in the same razor head. The bearing mechanisms can provide a larger pivoting range and less friction between the coupling of the razor head to a razor handle. This can result in smoother pivoting motion with better functionality. Furthermore, a pivoting center of the razor head with respect to a razor handle to be coupled to can be better adjusted since the space necessary for the coupling between razor head and razor handle can be reduced.

The razor head may comprise a shaving direction x, a perpendicular direction y which is perpendicular to the shaving direction x, and a vertical direction z which is perpendicular to the shaving direction x and the perpendicular direction y.

The frame may further comprise a leading longitudinal member defining a leading edge and a trailing longitudinal member defining a trailing edge, more specifically wherein a shaving plane SP can be defined on the skin-contacting side of the frame.

In embodiments, the first bearing mechanism can comprise a pair of arc-shaped bearing sections. The second bearing mechanism can comprise a pair of bearing cavities.

The pair of arc-shaped bearing sections and/or the pair of bearing cavities may extend parallel to the perpendicular direction y. In embodiments, the pair of arc-shaped bearing sections and/or the pair of bearing cavities can be oriented towards the geometric center of the razor head in the perpendicular direction, respectively.

The coupling section can comprise a pair of first walls which may be arc-shaped. In embodiments, the pair of first walls can be separated and/or aligned to each other with respect to the perpendicular direction y.

In embodiments, the pair of first walls can extend from a position proximate a side portion of the frame in the perpendicular direction y towards the geometric center of the razor head, respectively.

The pair of first walls may extend over a circumferential area with respect to a bearing axis BA that extends parallel to the perpendicular direction y.

The pair of bearing cavities may be formed between the back side and the pair of first walls, respectively.

The pair of first walls can comprise a first arc-shaped bearing surface that is oriented substantially in the vertical direction z, respectively. In embodiments, the first arc-shaped bearing surface may be defined by a radius of about 4.0 mm to 7.0 mm, more specifically of about 5.0 mm to 6.0 mm, in particular of about 5.2 mm to 5.8 mm.

The pair of first walls may each comprise a stopper wall that extends from the first arc-shaped bearing surface at a position proximate the geometric center of the razor head towards the trailing edge and the back side, more specifically under an angle with respect to the shaving plane SP.

The pair of first walls may each comprise a third arc-shaped bearing surface that is oriented towards the pair of bearing cavities. In embodiments, the third arc-shaped bearing surface may be defined by a radius of about 2.0 mm to 4.0 mm, more specifically of about 2.5 mm to 3.5 mm.

The coupling section can comprise at least one protrusion extending from the back side in the vertical direction z. In embodiments, the coupling section can comprise two protrusions extending from the back side in the vertical direction z, wherein the two protrusions can be separated and/or aligned to each other with respect to the perpendicular direction y.

The first bearing mechanism and the second bearing mechanism can be formed between the two protrusions in the perpendicular direction y. In embodiments, the pair of first walls can be arranged adjacent and between the two protrusions, respectively.

In the vertical direction z and from the back side, the coupling section can comprise the second bearing mechanism followed by the first bearing mechanism.

Each of the protrusions can comprise a second wall extending proximal an end of the respective protrusion in the perpendicular direction y towards a geometric center of the razor head. The second wall may define a second arc-shaped bearing surface. In embodiments, the second arc-shaped bearing surface (213) is defined by a radius of about 5.0 mm to 8.0 mm, more specifically of about 6.0 mm to 7.0 mm, in particular of about 6.2 mm to 6.9 mm.

The first arc-shaped bearing surface can extend over a circumferential area that is larger than a circumferential area over which the second arc-shaped bearing surface extends.

Starting from a position on the back side in the vertical direction z, the coupling section may comprise the pair of bearing cavities, followed by the pair of first walls, followed by the pair of arc-shaped bearing sections, followed by the pair of second walls.

In embodiments, the second arc-shaped bearing surface can extend parallel to the first arc-shaped bearing surface and/or to the third arc-shaped bearing surface.

The pair of arc-shaped bearing sections may be defined between the pair of first walls and the pair of second walls. More specifically, the pair of arc-shaped bearing sections may be defined between the first arc-shaped bearing surface and the second arc-shaped bearing surface.

The pair of first walls may each comprise a first length l1 and wherein the pair of second walls may each comprise a second length l2 measured parallel to the perpendicular direction y. In embodiments, the first length l1 can be larger than the second length l2.

In embodiments, the pair of first walls may each comprise a first wall portion having the first length l1 and a second wall portion having a third length l3. More specifically, the first length l1 can be larger than the third length l3.

With respect to the shaving plane SP, the first arc-shaped bearing surface and/or the second arc-shaped bearing surface may have a convex shape.

The pair of bearing cavities can each comprise a fourth arc-shaped bearing surface opposite the third arc-shaped bearing surface. More specifically, with respect to the shaving plane SP, the third arc-shaped bearing surface may have a convex shape and the fourth arc-shaped bearing surface may have a concave shape.

Each bearing cavity can comprise a bottom wall extending from a position proximate the leading edge towards the geometric center of the razor head under an angle δ, measured between the bottom wall and the shaving plane SP. The bottom wall may extend in the perpendicular direction y towards the geometric center of the razor head.

Each bearing cavity can comprise a side wall extending from the bottom wall at a position proximate the geometric center of the razor head substantially in the vertical direction z. The side wall can extend in the perpendicular direction y towards the geometric center of the razor head.

Each bearing cavity may be defined by the first wall, more specifically by the third arc-shaped bearing surface, by the fourth arc-shaped bearing surface, by the bottom wall and the side wall.

In embodiments, the coupling section can comprise a camming section. The camming section can comprise a camming wall extending from the back side in the vertical direction z. The camming wall may comprise a camming surface that extends parallel to the perpendicular direction y.

In embodiments, the trailing longitudinal member can comprise a trimming assembly provided on the trailing edge.

In embodiments, the razor head may further comprise a protecting cover configured to be releasably attached to the razor head.

The razor head may further comprise a connecting adapter, wherein the coupling section is releasably coupled to the connecting adapter via a pivotable or non-pivotable coupling, more specifically via the first and/or the second bearing mechanisms.

The connecting adapter may be pivotable about bearing axis BA with respect to the coupling section. The connecting adapter may be pivotable between a first position referring to a rest position and at least one second position referring to a pivoted position.

In embodiments, starting from the first position, the connecting adapter may be pivotable in a pivoting angle range of from 0°<μ≤50°, more specifically wherein the connecting adapter may be pivotable in one direction. Alternatively, starting from the first position, the connecting adapter may be pivotable in a pivoting angle range of from −25°≤μ≤+25°, more specifically wherein the connecting adapter may be pivotable in two directions.

In embodiments, the connecting adapter can comprise a biasing element configured to bias the connecting adapter with respect to the coupling section about the bearing axis BA. The biasing element can be a spring biased plunger translatable in the direction of longitudinal axis x1 of the connecting adapter. More specifically, the biasing element can comprise a cam follower adapted to engage with the camming surface. In embodiments, the biasing element may be configured to urge the razor head to the first position.

The connecting adapter can comprise a body portion having a first connecting portion arranged at a first end of the connecting body. More specifically, the first connecting portion can be configured to be coupled to the coupling section, in particular to the first bearing mechanism and/or to the second bearing mechanism.

In embodiments, the body portion can have a second connecting portion provided on an end of the body portion opposite the first connecting portion, wherein the second connecting portion can be configured to be coupled to a razor handle.

The second connecting portion can comprise an opening configured to receive a first end of a razor handle. In embodiments, the opening can comprise at least one detent provided on a wall of the opening.

The connecting adapter may comprise a longitudinal axis x1 and a perpendicular axis y1 that is perpendicular to the longitudinal axis x1, both extending through the geometric center of the connecting adapter.

In embodiments, the first connecting portion can comprise a pair of bearing pins configured to be inserted into the pair of bearing cavities. Each bearing pin of the pair of bearing pins can extend outwardly parallel to the perpendicular axis y1 and parallel to the longitudinal axis x1 from the body portion. In embodiments, each of the bearing pins can be V-shaped viewed in a plane x1-z1 defined by the longitudinal axis x1 and a vertical axis z1 that may be perpendicular to the longitudinal axis x1 and the perpendicular axis y1.

Each of the bearing pins can comprise a bottom side and a top side, wherein the V-shape of each of the bearing pins may include an angle λ.

The pivoting angle μ may be measured between the bottom side and the bottom wall and/or between the top side and the side wall.

In the first position, the bottom side may be parallel to the bottom wall and/or may bear against the bottom wall. Additionally or alternatively, in the at least one second position, the bottom side may lie under pivoting angle μ measured between bottom wall and the bottom side.

Each of the bearing pins can comprise a first arc-shaped bearing pin surface and a second arc-shaped bearing pin surface opposite the first arc-shaped bearing pin surface. With respect to the connecting body, the first arc-shaped bearing pin surface may have a convex shape and the second arc-shaped bearing pin surface may have a concave shape.

When the pair of bearing pins are inserted into the pair of bearing cavities, the first arc-shaped bearing pin surface can bear against the fourth arc-shaped bearing surface and the second arc-shaped bearing pin surface can bear against the third arc-shaped bearing surface.

In other embodiments, the first connecting portion may comprise a pair of arc-shaped bearings configured to be inserted into the pair of arc-shaped bearing sections. Each arc-shaped bearing of the pair of arc-shaped bearings can extend outwardly parallel to the perpendicular axis y1 from the body portion.

Each arc-shaped bearing of the pair of arc-shaped bearings can have a bottom side, a top side, a first side edge and a second side edge. With respect to the connecting body, the bottom side can have a concave shape and the top side can have a concave shape.

When the pair of arc-shaped bearings are inserted into the pair of arc-shaped bearing sections, the bottom side can bear against the first arc-shaped bearing surface and the top side can bear against the second arc-shaped bearing surface. In embodiments, the bottom side can be arc-shaped and defined by a radius of about 4.0 mm to 7.0 mm, more specifically of about 5.0 mm to 6.0 mm, in particular of about 5.2 mm to 5.8 mm. Additionally or alternatively, the top side can be arc-shaped and defined by a radius of about 5.0 mm to 8.0 mm, more specifically of about 6.0 mm to 7.0 mm, in particular of about 6.2 mm to 6.9 mm.

In embodiments, the connecting adapter can comprise an adapter shoulder configured to bear against the shoulder of the coupling section, more specifically in the first position.

In embodiments, in the at least one second position, the second side edge can bear against the stopper wall.

In an embodiment, the pivoting angle μ may be measured between the stopper wall and the second side edge.

The frame can comprise a plurality of cutting member guides defining a plurality of cutting member support slots, wherein each cutting member support slot may be configured to accommodate a longitudinal cutting member. The frame may further comprise a plurality of longitudinal cutting members, wherein each cutting member may be disposed in a respective cutting member support slot.

In embodiments, the frame can comprise at least one C-shaped cutting member retainer, configured to be pushed onto the frame at the side portion in the perpendicular direction y. The at least one cutting member retainer can be configured to retain the plurality of cutting members when inserted in the plurality of cutting member support slots.

According to a second aspect of the present disclosure, a kit of parts is provided which comprises a razor cartridge holder comprising a plurality of razor heads according to any one of the embodiments as described above. The kit of parts further comprises a razor handle.

According to a third aspect of the present disclosure, a razor comprises a razor head according to any one of the embodiments as described above, and a razor handle, wherein the razor head is coupled to the razor handle.

The razor handle can be coupled to the razor head via the connecting adapter. In embodiments, the connecting adapter can be integrally formed with the razor handle. Alternatively, the connecting adapter can be releasably coupled to the razor handle.

In embodiments, the razor handle can comprise a retention and/or release mechanism configured to couple the razor head to the razor handle and/or to decouple the razor head from the razor handle.

According to a fourth aspect of the present disclosure, a method of assembling a razor is provided which comprises the steps of providing a razor handle, providing a razor head according to any one of the embodiments as described above, and coupling the razor handle to the razor head.

In an embodiment, the connecting adapter can be integrally formed with the razor handle and coupling the razor handle to the razor head may comprise coupling the razor handle to the coupling section, more specifically to the first bearing mechanism or to the second bearing mechanism, via the connecting adapter.

In another embodiment, the connecting adapter can be a separate component and coupling the razor handle to the razor head may comprise coupling the connecting adapter to the coupling section, more specifically to the first bearing mechanism or to the second bearing mechanism, and coupling the connecting adapter to the razor handle.

### BRIEF DESCRIPTION OF THE DRAWINGS

Other characteristics will be apparent from the accompanying drawings, which form a part of this disclosure. The drawings are intended to further explain the present disclosure and to enable a person skilled in the art to practice it. However, the drawings are intended as non-limiting examples. Common reference numerals on different figures indicate like or similar features.

FIGS. 1A to 1D are schematic views of a razor and a razor head according to the present disclosure;

FIGS. 2A to 2C are schematic views of the razor, wherein the razor head is pivotable between first and second positions;

FIG. 3 is an exploded view of the razor head according to the first aspect of the present disclosure;

FIGS. 4A to 4C are an isometric view of the razor head on the back side, a side view of the razor head at the leading edge, and a front view of the razor head on the skin-contacting side;

FIG. 5 is a cut-away view of the razor head at a position between camming section and first wall, parallel to the x-z plane;

FIGS. 6A to 6D are schematic views of the razor head according to the first aspect of the present disclosure, and cutaway views of the razor head at sections A-A and B-B shown in FIG. 6A;

FIGS. 7A and 7B are a schematic view of the back side of the razor head and a cutaway view of the razor head at a position between camming section and protrusion in front of the first wall;

FIG. 8 is a schematic view of a longitudinal cutting member;

FIGS. 9A to 9D are schematic views of a connecting adapter according to a second embodiment;

FIGS. 10A to 10D are schematic views of the connecting adapter according to the second embodiment, coupled to the razor head via the second bearing mechanism;

FIGS. 11A to 11D are schematic views of a connecting adapter according to a first embodiment;

FIGS. 12A to 12D are schematic views of the connecting adapter according to the first embodiment, coupled to the razor head via the first bearing mechanism;

### DETAILED DESCRIPTION

Embodiments of the razor head, the kit of parts, the razor and the method of assembling a razor according to the present disclosure will be described in reference to the drawings as follows.

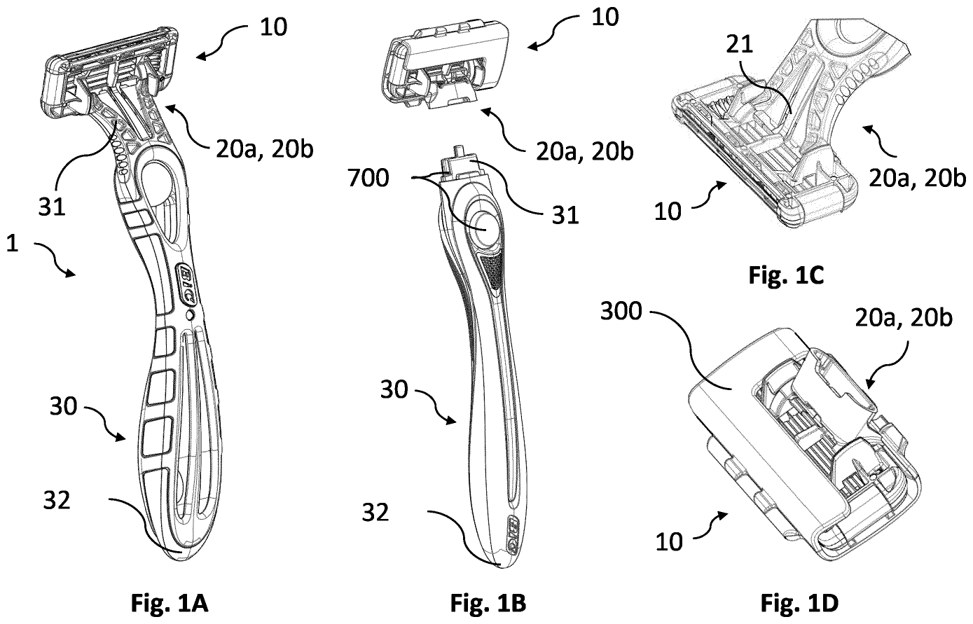

FIGS. 1A to 1D are schematic views of a razor 1 and a razor head 10 according to the present disclosure. The razor 1 comprises a razor head 10 and a razor handle 30, wherein the razor head 10 is coupled to the razor handle 30 (see, e.g., FIG. 1A). The razor handle 30 comprises a first end 31 and a second end 32. The razor handle 30 is coupled to the razor head 10 via a connecting adapter 20a, 20b. As shown in FIGS. 1A and 1C, the connecting adapter 20a, 20b can be integrally formed with the razor handle 30. Alternatively, the connecting adapter 20a, 20b can be releasably coupled to the razor handle 30 (see, FIGS. 1B and 1D). In embodiments, the razor head 10 can be coupled to the razor handle 30, more specifically to the connecting adapter 20a, 20b, via positive locking. However, the positively locking connection may allow pivoting of the razor head 10 with respect to the razor handle 30 and/or the connecting adapter 20a, 20b, which will be described in more detail below.

In use (wherein the razor head 10 may be coupled to the razor handle 30), a user holds the razor handle 30 in a shaving direction x and brings the razor head 10 into contact with a portion of skin. In examples, a shaving plane SP is defined as the tangential line intersecting the first and second skin contact points of, for example, cutting members of the razor head 10. In other examples, the shaving plane SP may be approximated as a tangential line between the highest points on the skin-contacting surface of a razor head 10—for example, the flat plane between the top of a guard and the top of a cap of the razor head 10. During a shaving operation, movement of the razor handle 30 causes cutting members of the razor head 10 to be moved across the shaving plane SP in the shaving direction x, enabling the cutting members to remove unwanted hair.

In the following specification and claims, the term “cutting member” means a component of a razor head 10 that, in use, contacts the skin of a user and cuts protruding hairs. A cutting member can be a razor blade having a blade with a cutting edge glued, or laser welded, to a separate bent support member. The bent support member can be fitted into a cutting member support slot in-between two opposed cutting member guides, such as protrusions from a transverse frame member of the razor cartridge. The blade can be attached to the face of the bent support member that faces towards a user of the razor cartridge, in use. Alternatively, the blade can be attached to the face of the bent support member that faces away from a user of the razor cartridge, in use. In this latter case, each cutting member has two contact points with the skin of the user (the blade edge, and the distal end of the bent support member), to thus reduce pressure on the user's skin. Alternatively, the cutting member may be a “bent blade”. This is an integrally formed cutting member comprising a radiused bend, and a cutting edge formed at a distal end of the radiused bend. A movable cutting member or a movable bent blade may be a cutting member which is movable in the housing, more specifically in the cutting member support slot, in a direction perpendicular to the shaving plane. The movable cutting member may be biased by at least one biasing element which is configured to exert a biasing force on the respective cutting member towards the shaving plane, wherein the cutting member is in a rest position. In embodiments, the at least one biasing element may be a plurality of resilient fingers. In the rest position, the cutting edges of the cutting members may bear against a corresponding stop portion. A “plurality of cutting members” may consist of the same type of cutting members, or may comprise at least one bent blade, or another type of blade for example.

In the following specification and claims, the term “leading” means the side of the razor head that contacts a portion of a user's skin first, in normal use. In the following specification and claims, the term “trailing” means the side of the razor head 10 that contacts a portion of a user's skin last, in normal use.

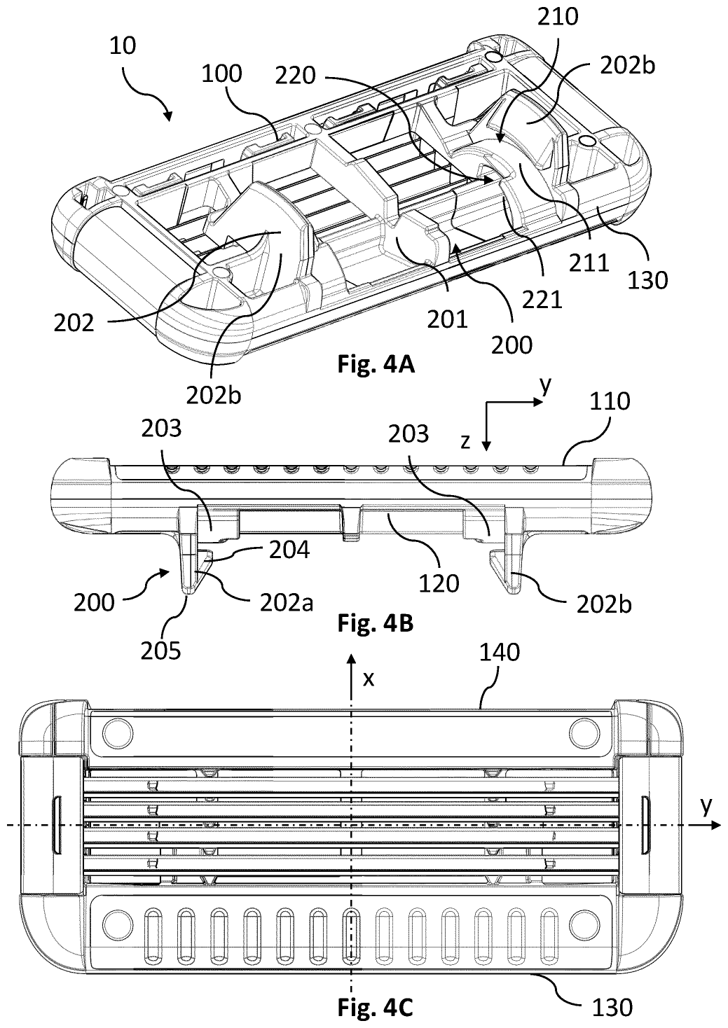

FIGS. 4A to 4C are schematic views of the razor head 10. The razor head 10 comprises a frame 100 having a skin-contacting side 110 and a back side 120 opposite the skin-contacting side 110. The skin-contacting side 110 can face a user's skin during a shaving operation. A coupling section 200 is arranged on the back side 120, wherein the coupling section 200 is configured to couple the razor head 10 to a razor handle 30. The coupling section 200 comprises a first bearing mechanism 210 and a second bearing mechanism 220 that are functionally different. Due to the coupling section 200 comprising the functionally different bearing mechanisms 210, 220, different types of razor handles (e.g. disposable razor handles) can be coupled to the razor head 10. The razor head 10 according to the present disclosure can lead to ergonomic and functional improvements.

Functionally different does not exclude the possibility that the two bearing mechanisms 210, 220 are, e.g., both pivoting mechanisms. Rather functionally different may mean that the bearing mechanisms 210, 220 differ at least slightly in structure whereby not only a mirroring of a component is meant, but a “real” structural difference and/or that the bearing mechanisms 210, 220 are adapted to interact with another component e.g. the razor handle 30, more specifically the connecting adapter 20a, 20b in at least a slightly different way, respectively. E.g., bearing surfaces may be different of the respective bearing mechanism 210, 220 when coupled to another component like the connecting adapter 20a, 20b.

At least one of the first and the second bearing mechanisms 210, 220 can be a pivoting mechanism. More specifically, each of the first and second bearing mechanisms 210, 220 can be a pivoting mechanism. Thus, the bearing mechanisms 210, 220 can support different kinds of pivoting mechanisms in the same razor head 10. The bearing mechanisms 210, 220 can provide a larger pivoting range and less friction when the razor head 10 is coupled to a razor handle 30. This can result in smoother pivoting motion with better functionality. Furthermore, a bearing axis BA of the razor head 10 with respect to a razor handle 10 to be coupled to can be better adjusted since the space necessary for the coupling between razor head 10 and razor handle 30 (and/or connecting adapter 20a, 20b) can be reduced.

As shown, e.g., in FIGS. 4B and 4C, the razor head 10 comprises a shaving direction x, a perpendicular direction y which is perpendicular to the shaving direction x, and a vertical direction z which is perpendicular to the shaving direction x and the perpendicular direction y.

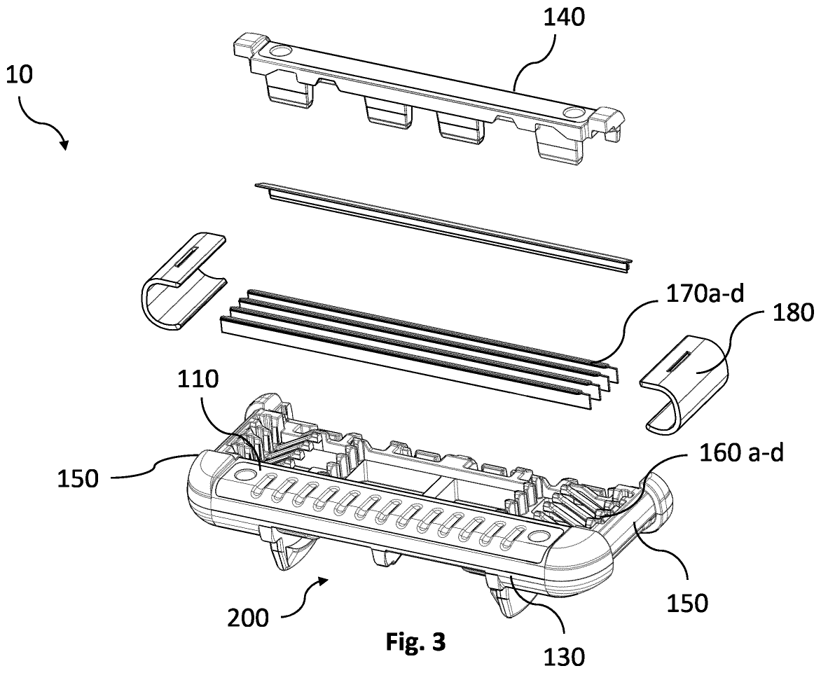

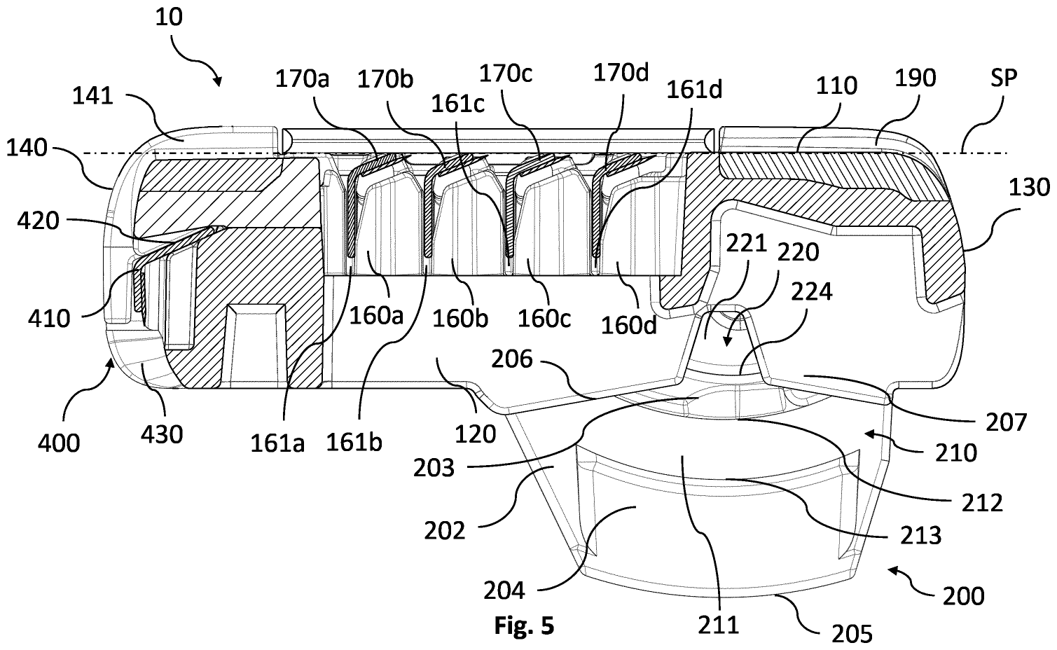

FIG. 3 is an exploded view of the razor head 10 according to the first aspect of the present disclosure and FIG. 5 is a detailed schematic view of the razor head 10. Referring to FIGS. 3 to 5, the frame 100 further comprises a leading longitudinal member defining a leading edge 130 and a trailing longitudinal member defining a trailing edge 140, and a side portion 150, more specifically wherein the shaving plane SP is defined on the skin-contacting side 110 of the frame 100. The shaving direction x and the perpendicular direction y may lie in the shaving plane SP which is on the skin-contacting side 110, or, in a geometric center of the frame 100.

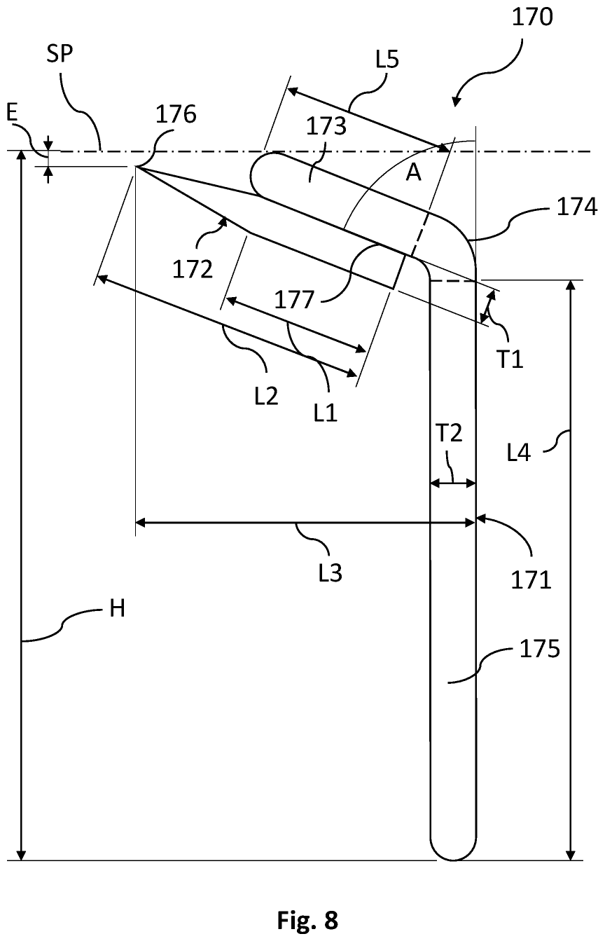

The frame 100 comprises a plurality of cutting member guides 160a-d defining a plurality of cutting member support slots 161a-d. Each cutting member support slot 161a-d is configured to accommodate a longitudinal cutting member 170a-d. The frame 100 may further comprise a plurality of longitudinal cutting members 170a-d, wherein each cutting member 170a-d is disposed in a respective cutting member support slot 161a-d. Detailed embodiments of the plurality of cutting members 170a-d will be described with reference to FIG. 8 below. Although four cutting members 170a-d are shown in the Figs., it should be noted that the razor head 10 may comprise at least one cutting member, including but not limited to, one, two, three, four, five, six, seven or more cutting members.

FIG. 8 is a schematic side view of an embodiment of a cutting member 170 of the plurality of cutting members 170a-d. As shown in FIG. 8, the cutting member 170 may be a sub-assembly comprising a longitudinal blade 172 mounted on a longitudinal blade support 171. The longitudinal blade support 171 comprises a substantially elongated lower portion 175, more specifically a flat lower portion 175, which is suitable for being held in at least one holding slot of the frame 100, a substantially elongated top portion 173, more specifically a flat top portion 173, and a radius bent portion 174. The bent portion 174 is arranged between the lower portion 175 and the top portion 173 and defines an angle of approach A of the blade 172 with respect to the shaving plane SP. The top portion 173 comprises an inner surface 177. The approach angle A defines the angle of declination of an inner surface 177 of the top portion 173 from the reference of the blade support 171 (more specifically, of the lower portion 175). In an example, A is an acute angle, specifically between 60 and 75 degrees, more specifically between 65 and 70 degrees, in particular 68 degrees. The blade 172 is mounted on the inner surface 177 of the blade support 171, more specifically of the top portion 173. In embodiments, the radius bent portion 174 may have an inner radius of curvature RI of at least 0.1 mm. The radius bent portion 174 may have an inner radius of curvature RI that is less than 0.9 mm. A minimum recommended inner radius of curvature RI of sheet metal should be at least the same as its thickness T2, wherein T2 is the thickness of the blade support 171. A safety factor of the thickness of the blade support 171 may be applied. By multiplying the safety factor with the preferable thickness of T2, the inner radius of curvature RI may be approximately between 0.15 mm and 0.30 mm, more specifically between 0.18 mm and 0.25 mm, and in particular between 0.19 mm and 0.21 mm. The radius bent portion 174 may have an outer radius of curvature RO, which may be approximately between 0.20 mm and 0.50 mm, more specifically between 0.30 mm and 0.40 mm, and in particular between 0.34 mm and 0.36 mm.

In examples, the exemplary cutting member 170 may comprise a blade support 171 including the top portion 173 having an inner surface 171 that, in use, faces away from the shaving plane SP and a blade 172 attached to the inner surface 177 of the top portion 173. In other words, the blade 172 may be mounted “underneath the blade support 171”. The phrase “underneath the blade support” for the purposes of this specification and claims means a side of the blade support 171 that is furthest from a shaving plane SP (and/or skin) of a user when the razor head is in use. The blade 172 includes a cutting edge 176. In embodiments and as described above, one, two, three, four, five, six, seven or more cutting members 170 may be provided. If a plurality of cutting members 170 are provided, one or more of the cutting members 170 may comprise the blade support 171 including the top portion 173 having an inner surface 177 that, in use, faces away from the shaving plane SP and a blade 176 attached to the inner surface 177 of the top portion 173, as described above. In embodiments, each of the cutting members 170 may comprise the blade support 171 including the top portion 173 having an inner surface 177 that, in use, faces away from the shaving plane SP and a blade 176 attached to the inner surface 177 of the top portion 173, as described above.

In an embodiment, the razor head 10 may comprise a plurality of cutting members 170a-d oriented (and/or configured to shave) in the shaving direction x and/or towards the leading edge 130. In embodiments, the plurality of cutting members 170a-d may be fixed to the razor head, more specifically to the frame 100, in particular fixedly arranged in respective cutting member support slots 161a-d. In other words, these cutting members may not be movable in the razor head 10 (more specifically in the frame 100). However, in embodiments, all cutting members of the plurality of cutting members 170a-d may be movable within the razor head 10, more specifically in the respective cutting member support slots 161a-d, or in another embodiment some cutting members of the plurality of cutting members 170a-d may be movable while others may be fixed.

The inner surface 177 may be a bottom surface of the blade support 171, or in other words, a surface of the blade support 171 which is opposite the top (in particular a top side) of the blade support 171, more specifically of the top portion 173. The phrase “top of the blade support” for the purposes of this specification and claims means a side of a blade support 171 that is closest to a shaving plane SP (and/or skin) of a user when the razor head 10 is in use.

The blade support 171 may be made from a flat sheet metal part which is bent before welding of the blade 172 on the inner surface 177 of the blade support 171 at the top portion 173. The flat sheet metal part may derive from a metal wire which has been flattened i.e. by rolling process. The lower portion 175 may have a length L4 of at least 1.0 mm. In embodiments, the length L4 may be between 1.1 mm and 1.8 mm, more specifically between 1.20 mm and 1.40 mm, in particular between 1.20 mm and 1.25 mm. The top portion 173 may have a length L5 of at least 0.50 mm. In embodiments, the length L5 may be between 0.50 mm and 0.90 mm, more specifically between 0.60 mm and 0.85 mm, in particular between 0.74 mm and 0.80 mm. The blade 172 has a flat connection portion with a thickness T1, which can be about 0.1 mm (for example, between 0.04 and 0.11 mm). In embodiments, the thickness T1 may be between 0.06 mm and 0.09 mm, more specifically between 0.07 mm and 0.08 mm. The total length L2 of the blade 172 between the cutting edge 176 of the blade 172 and an opposite back edge of the blade 172 can be about 1 mm (for example, between 0.8 mm and 1.3 mm). In embodiments, the total length L2 of the blade 172 may be between 0.90 mm and 1.20 mm, more specifically between 1.06 mm and 1.16 mm. The flat connection portion of the blade 172 that is in contact with the inner surface 177 of the top portion 173 of the blade support 171 that, in use, faces away from the shaving plane SP can have a length L1 that is about 0.49 mm+/−0.1 mm long.

However, in embodiments, the length L1 can be between 0.30 mm and 0.90 mm, more specifically between 0.40 mm and 0.70 mm. The distance between the cutting edge 176 and a rounded edge of the top portion 173 may be about 0.3 mm, measured parallel to the blade 172, more specifically to the connection portion. In this way, a good retention of the blade on the underside of the blade support 171 (the inner surface 177 of the blade support 171) may be ensured.

In an example, a height H of the exemplary cutting member 170 may be between 1.75 mm and 2.00 mm, in particular between 1.84 mm and 1.92 mm. In other embodiments, the height H may be between 2.53 mm and 2.63 mm, particularly about 2.58 mm. In an example, a front end of the blade support 171, more specifically of the top portion 173, may be rounded or chamfered to improve gliding properties of the cutting member 170. In an example, the blade 172 may be positioned on the inner surface 177 of the blade support 171 to adjust an exposure E of the cutting edge 176 positively or negatively compared to the shaving plane SP. The exposure is a measure of how prominently the cutting edge 176 of a blade protrudes above or sinks below the end of its blade support 171. In an example, the blade 172 may be positioned to have an exposure E relative to the shaving plane SP in the range of −80 μm to +80 μm, specifically an exposure of about −75 μm, −65 μm, −60 μm, −55 μm, −50 μm, −45 μm, −40 μm, −35 μm, −30 μm, −25 μm, −20 μm, −15 μm, −10 μm, −5 μm, 0 μm, 5 μm, 10 μm, 15 μm, 20 μm, 25 μm, 30 μm, 35 μm, 40 μm, 45 μm, 50 μm, 55 μm, 60 μm, 65 μm, 70 μm, or 75 μm. A length L3 of the cutting member 170, measured between the cutting edge 176 and an outer face of the lower portion 175 of the blade support 171 may be about 1.0 mm (for example, between 0.9 mm and 1.6 mm). The blade 172 may be fixed on the inner surface 177 of the blade support 171 by any known means, such as but not limited to, by laser spot welding. In examples, the blade 172 may be fixed on the inner surface 177 of the blade support 171 by a plurality of spot welds (for example, between ten and sixteen spot welds) distributed along the longitudinal dimension of the blade support 171. Each of the spot welds may be performed on the inner face of the blade. Alternatively, each of the spot welds may be carried out on the outer surface of the blade support 171, or a mixture of the two.

When shaving, the blade support(s) 171 of the cutting members 170a-d may be brought into contact with the skin (shaving plane SP) in addition to the cutting edges 176 of the blade 172. Therefore, the number of contact points between the razor head 10 and the skin is increased, up to being doubled. The amount of pressure exerted on a portion of skin by each cutting edge 176 can be significantly reduced, leading to fewer incidents of skin injury (“nicking”) and a more comfortable shave. The blade 172 is mounted on an inner surface 177 of the blade support 171 to enable the blade support 171 to simultaneously contact the skin at the same time as the cutting edge 176 of the blade 172, in use. This means that the portions of the blade support 171 in contact with the skin reduce or minimize the “skin bulge”, thus reducing the risk of nicks and cuts occurring. Another effect is that durability of the blades can be prolonged, since less pressure is applied to the skin thus resulting in a less aggressive shaving and therefore the blades can wear at a lower rate.

As shown in FIG. 3, the frame 100 comprises at least one C-shaped cutting member retainer 180 configured to be pushed onto the side portion 150 of the frame 100 in the perpendicular direction y. The at least one cutting member retainer 180 is configured to retain the plurality of cutting members 170a-d when inserted in the plurality of cutting member support slots 161a-d. In embodiments, the at least one cutting member retainer 180 can be connected to the side portion 150 of the frame 100 by a positively locking connection.

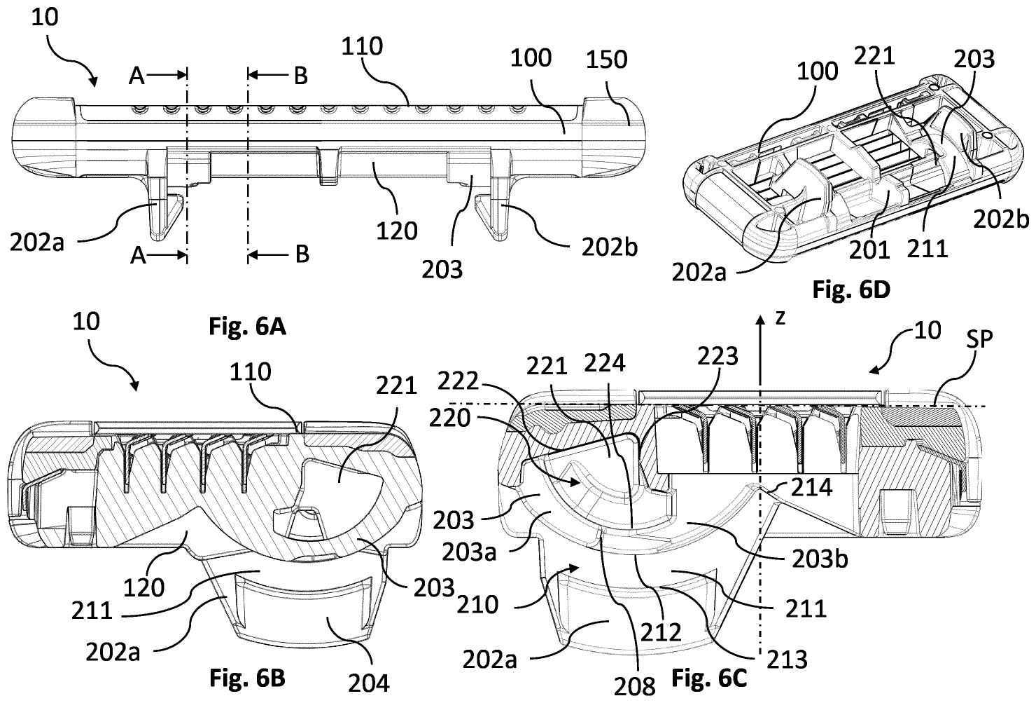

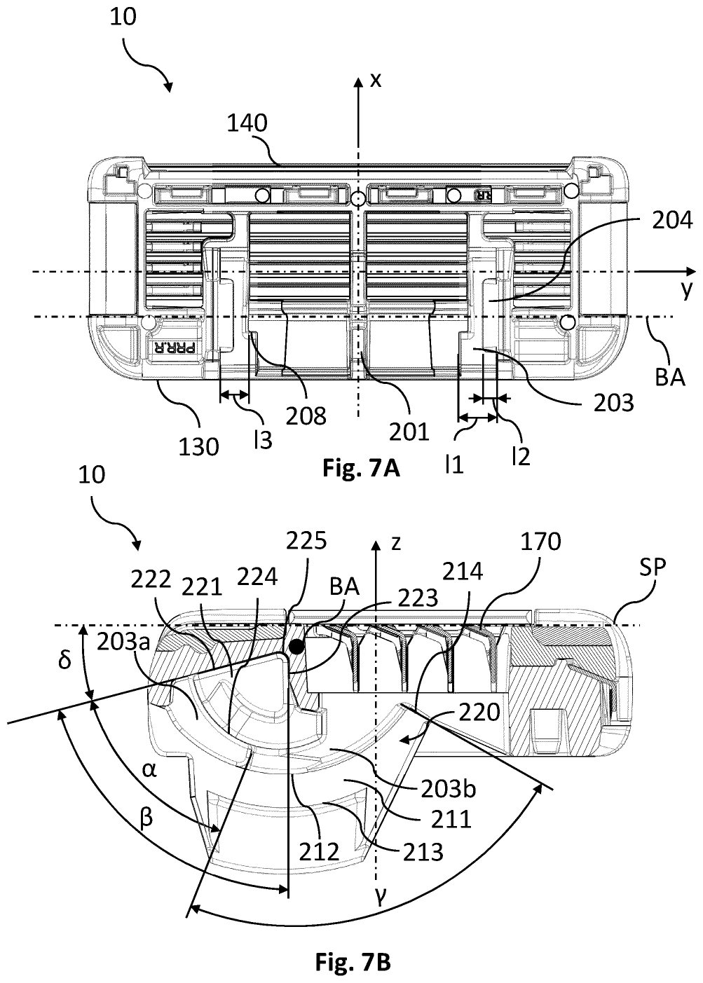

FIGS. 6A to 6D are schematic views of the razor head 10 according to the first aspect of the present disclosure, and cutaway views of the razor head at sections A-A and B-B shown in FIG. 6A. FIGS. 7A and 7B are a schematic view of the back side of the razor head and a cutaway view of the razor head at a position between camming section and protrusion in front of the first wall. As shown in FIGS. 6A to 7D, the first bearing mechanism 210 comprises a pair of arc-shaped bearing sections 211. The pair of arc-shaped bearing sections 211 are separated to each other and/or aligned to each other in the perpendicular direction y. The second bearing mechanism 220 comprises a pair of bearing cavities 221. The pair of arc-shaped bearing cavities 212 are separated to each other and/or aligned to each other in the perpendicular direction y.

The pair of arc-shaped bearing sections 211 and/or the pair of bearing cavities 221 extend parallel to the perpendicular direction y. More specifically, the pair of arc-shaped bearing sections 211 and/or the pair of bearing cavities 221 are oriented towards the geometric center of the razor head 10 in the perpendicular direction y, respectively.

As best shown in FIGS. 6A to 6D, the coupling section 200 comprises a pair of first walls 203 which are arc-shaped, more specifically wherein the pair of first walls 203 are separated and/or aligned to each other with respect to the perpendicular direction y. The pair of first walls 203 extend from a position proximate the side portion 150 in the perpendicular direction y towards the geometric center of the razor head 10, respectively. The pair of first walls 203 extend over a circumferential area with respect to a bearing axis BA that extends parallel to the perpendicular direction y. The bearing axis BA will be described in more detail below. With respect to the skin-contacting side 110, the pair of first walls 203 may have a convex shape.

The pair of first walls 203 extend from a position proximate the leading edge 130 towards the geometric center of the razor head 10 in the shaving direction x. The pair of bearing cavities 221 are formed between the back side 120 and the pair of first walls 203, respectively.

The pair of first walls 203 comprise a first arc-shaped bearing surface 212 that is oriented substantially in the vertical direction z, respectively. In embodiments, the first arc-shaped bearing surface 212 may be defined by a radius of about 4.0 mm to 7.0 mm, more specifically of about 5.0 mm to 6.0 mm, in particular of about 5.2 mm to 5.8 mm. Furthermore, the pair of first walls 203 each comprise a third arc-shaped bearing surface 224 that is oriented towards the pair of bearing cavities 221. In embodiments, the third arc-shaped bearing surface 224 may be defined by a radius of about 2.0 mm to 4.0 mm, more specifically of about 2.5 mm to 3.5 mm.

As best shown in FIG. 7B, the pair of first walls 203 each comprise a stopper wall 214 that extends from the first arc-shaped bearing surface 212 at a position proximate the geometric center of the razor head 10 towards the trailing edge 140 and the back side 120, more specifically under an angle with respect to the shaving plane SP.

The coupling section 200 comprises at least one protrusion 202 extending from the back side 120 in the vertical direction z. In an embodiment, only one protrusion 202 can extend from the back side 120 of the frame 100. In this case, the protrusion 202 can be arranged in the middle, more specifically in the geometric center of the razor head 10 with respect to the perpendicular direction y, proximate the leading edge 130 and/or parallel to the side portion 150 of the frame 100. The pair of bearing cavities 221 and the pair of arc-shaped bearing sections 211 may be provided in the perpendicular direction y on each side of the protrusion 202. In this embodiment, the pair of bearing cavities 221 and the pair of arc-shaped bearing sections 211 may be oriented towards the side portion 150 in the perpendicular direction y, respectively.

In the embodiments shown, e.g., in FIGS. 4A to 7B, the coupling section 200 comprises two protrusions 202a, 202b extending from the back side 120 in the vertical direction z, wherein the two protrusions 202a, 202b are separated and/or aligned to each other with respect to the perpendicular direction y. The two protrusions 202a, 202b may be operable only when the first bearing mechanism 210 is used, e.g., when the razor head 10 is coupled to the connecting adapter 20b via the first bearing mechanism 210. Their functionality is to guide and keep the connecting adapter 20b steady during a pivoting motion. The first bearing mechanism 210 and/or the second bearing mechanism 220 are formed between the two protrusions 202a, 202b in the perpendicular direction y. In the perpendicular direction y, the pair of first walls 203 are arranged adjacent and between the two protrusions 202a, 202b, respectively.

Referring to FIGS. 6C and 7B, in the vertical direction z and from the back side 120, the coupling section 200 comprises the second bearing mechanism 220 followed by the first bearing mechanism 210. Each of the protrusions 202a, 202b comprises a second wall 204 extending proximal an end 205 of the respective protrusion 202a, 202b in the perpendicular direction y towards a geometric center of the razor head 10, wherein the second wall 204 defines a second arc-shaped bearing surface 213. In embodiments, the second arc-shaped bearing surface 213 may be defined by a radius of about 5.0 mm to 8.0 mm, more specifically of about 6.0 mm to 7.0 mm, in particular of about 6.2 mm to 6.9 mm. The first arc-shaped bearing surface 212 extends over a circumferential area that is larger than a circumferential area over which the second arc-shaped bearing surface 213 extends. Starting from a position on the back side 120 in the vertical direction z, the coupling section 200 comprises the pair of bearing cavities 221, followed by the pair of first walls 203, followed by the pair of arc-shaped bearing sections 211, followed by the pair of second walls 204. The pair of arc-shaped bearing sections 211 are defined between the pair of first walls 203 and the pair of second walls 204, more specifically between (or by) the first arc-shaped bearing surface 212 and the second arc-shaped bearing surface 213. With respect to the shaving plane SP (and/or the skin-contacting side 110), the first arc-shaped bearing surface 212 and/or the second arc-shaped bearing surface 213 have a convex shape.

In the embodiments shown, the second arc-shaped bearing surface 213 extends parallel to the first arc-shaped bearing surface 212 and/or to the third arc-shaped bearing surface 224. In other embodiments, the second arc-shaped bearing surface 213 may not extend parallel to the first arc-shaped bearing surface 212 and/or the third arc-shaped bearing surface 224.

As shown in FIG. 7A, the pair of first walls 203 each comprise a first length l1 and the pair of second walls 204 each comprise a second length l2, measured parallel to the perpendicular direction y. In the embodiments shown, the first length l1 is larger than the second length l2. In embodiments, the pair of first walls 203 may each comprise a first wall portion 203a having the first length l1 and a second wall portion 203b having a third length (l3), more specifically wherein the first length l1 may be larger than the third length l3. In these embodiments, a shoulder 208 is formed between first wall portion 203a and second wall portion 203b. When the razor head 10 is coupled to the connecting adapter 20b, the shoulder 208 can function as a stop as will be described below. The first wall portion 203a may extend over a circumferential area a measured with respect to bearing axis BA and between shoulder 208 and bottom wall 222. In a rest position of the razor head (in an unoperated state), a component of the connecting adapter 20b, more specifically an adapter shoulder 616, may bear against the shoulder 208.

Referring to FIGS. 6C and 7B, the pair of bearing cavities 221 each comprise a fourth arc-shaped bearing surface 225 opposite the third arc-shaped bearing surface 224. More specifically, with respect to the shaving plane SP (or the skin-contacting side 110), the third arc-shaped bearing surface 224 has a convex shape and wherein the fourth arc-shaped bearing surface 225 has a concave shape. Each bearing cavity 221 comprises a bottom wall 222 extending from a position proximate the leading edge 130 towards the geometric center of the razor head 10 under an angle δ, measured between the bottom wall 222 and the shaving plane SP. The bottom wall 222 extends in the perpendicular direction y towards the geometric center of the razor head 10. Each bearing cavity 221 comprises a side wall 223 extending from the bottom wall 222 at a position proximate the geometric center of the razor head 10 in the shaving direction x substantially in the vertical direction z. The side wall 223 extends in the perpendicular direction y towards the geometric center of the razor head 10. As shown in FIGS. 6C and 7B, the fourth arc-shaped bearing surface 225 is arranged between bottom wall 222 and side wall 223. In other words, it can be defined that the coupling section 200 comprises the bottom wall 222, the fourth arc-shaped bearing surface 225 and the side wall 223 as described above on the back side 120. Since the two protrusions 202a, 202b are arranged adjacent the pair of bearing cavities 221 on each side between bearing cavity 221 and side portion 150, the bottom wall 222, the fourth arc-shaped bearing surface 225 and the side wall 223 may extend on the back side 120 between the two protrusions 202a, 202b in the perpendicular direction y. Each bearing cavity 221 can be defined by the first wall 203, more specifically by the third arc-shaped bearing surface 224, by the fourth arc-shaped bearing surface 225, by the bottom wall 222 and the side wall 223.

As best shown in FIGS. 4A, 5 and 7A, the coupling section 200 comprises a camming section 201. The camming section 201 comprises a camming wall 207 extending from the back side 120 in the vertical direction z, wherein the camming wall 207 comprises a camming surface 206 that extends parallel to the perpendicular direction y. The camming surface 206 is oriented substantially in the vertical direction z. The camming wall 207 extends from the leading edge 130 in the shaving direction x (or in other words, parallel to the side portions 150 and/or parallel to the protrusions 202a, 202b). With respect to the perpendicular direction y, the camming wall 207 is arranged symmetrical between the two protrusions 202a, 202b and/or the side portions 150. In the embodiment shown in FIG. 5, starting from the leading edge 130 in the shaving direction x and viewed in the x-z-plane, the camming wall 207 can comprise a first portion that extends linearly in the shaving direction x, followed by a recess that extends in the vertical direction z towards the skin-contacting side 110, followed by a second portion that extends linearly and at least partially towards the trailing edge 140. The first and second portions may be slightly angled towards the recess with respect to the shaving plane SP.

As indicated in FIG. 7B, the first bearing mechanism 210 comprises a first pivoting range γ measured with respect to bearing axis BA. The second bearing mechanism 220 comprises a second pivoting range R measured with respect to bearing axis BA. However, the true pivoting range, more specifically a pivoting range angle μ, results after coupling of the razor head 10 to the razor handle 30 and is thus dependent on the structural characteristics of the bearing components, e.g., the connecting adapter 20a, 20b, to which the razor head 10 may be coupled to.

In embodiments, as shown in FIG. 5, the trailing longitudinal member may comprise a longitudinal skin care element 141 (e.g. a lubricating strip) for applying a compound, such as a lubricating compound, to the shaving plane SP after the plurality of cutting members 170a-d have passed over a user's skin. The leading longitudinal member may comprise a guard member 190 which may be located proximate the shaving plane SP. The guard member 190 can comprise an elastomeric member (not shown in FIG. 5). The elastomeric layer may comprise one or more fins extending longitudinally in parallel to the guard member 190 and substantially perpendicularly to the shaving direction x. One purpose of such an elastomeric layer is, for example, to tension the skin prior to cutting.

In embodiments, the trailing longitudinal member can further comprise a trimming assembly 400, more specifically a longitudinal trimming assembly 400, provided on the trailing edge 140. A skilled person will appreciate that the example trimming assembly 400 may be omitted without loss of generality. The trimming assembly 400 can comprise a longitudinal trimming cutting member 410 disposed on the trailing edge 140 of the razor head 10. The trimming cutting member 410 may, for example, be used for trimming hairs that are awkward to reach using the plurality of cutting members 170a-d, such as extraneous nasal hairs, or to be able to improve shaving beard contours. The trimming assembly 400 may further comprise a trimming cutting member support slot 420 which is configured to accommodate the trimming cutting member 410. As shown in FIG. 5, the trimming cutting member 410 is disposed in the trimming cutting member support slot 420. In an embodiment, the trimming cutting member 410 can only extend across a proportion of the longitudinal direction of the trimming assembly 400, such as up to three quarters, up to one half, or up to one quarter. The trimming cutting member 410 may have an identical design with respect to cutting members 170a-d in order to reduce parts variation. Alternatively, the trimming cutting member 400 can have a different design to the design of the cutting members 170a-d. The trimming cutting member 410 is not comprised within the plurality of cutting members 170a-d intended to contact the shaving plane SP. More specifically, the trimming cutting member 410 may be oriented with its cutting edge toward the back side 120 of the razor head in the vertical direction z. In an embodiment, the trimming assembly 400 may comprise a retractable cover 430 as a safety feature, and to keep the trimming cutting member 410 sharp when not in use.

As indicated in FIGS. 7A and 7B, the first bearing mechanism 210 and the second bearing mechanism 220 can comprise at least one bearing axis BA which extends parallel to the perpendicular direction y. More specifically, the at least one bearing axis BA may be a virtual bearing axis about which the razor head 10 pivots when coupled to the razor handle 30, more specifically to the connecting adapter 20a, 20b. In embodiments, the first bearing mechanism 210 and the second bearing mechanism 220 can comprise one common bearing axis BA, wherein the bearing axis BA may be located between leading edge 130 and first cutting member 170d, viewed from the leading edge 130 towards the trailing edge 140 in the shaving direction x. The bearing axis BA may be located proximate the skin-contacting side (and/or shaving plane SP). In other words, the bearing axis BA may be located in the area of the guard bar 190, which is arranged between first cutting member 170d and leading edge 130 adjacent the skin-contacting side 110. In another embodiment, the first bearing mechanism 210 can have a first bearing axis and the second bearing mechanism 220 can have a second bearing axis. The first bearing axis may be different from the second bearing axis. In case the razor head is coupled to the razor handle 30, more specifically to the connecting adapter 20a, 20b, via the first bearing mechanism 210, the razor head 10 may pivot about the first bearing axis. In case the razor head is coupled to the razor handle 30, more specifically to the connecting adapter 20a, 20b, via the second bearing mechanism 220, the razor head 10 may pivot about the second bearing axis. In should be understand that the location of the respective bearing axes depends on the structural dimensions and/or arrangements of the coupling section, the bearing component to be coupled to, and/or first and second bearing mechanisms 210, 220. The first bearing axis may be located in the shaving direction x between the second and third cutting members 170b, 170c, more specifically proximate the skin-contacting side 110. The second bearing axis may be located between leading edge 130 and first cutting member 170d, viewed from the leading edge 130 towards the trailing edge 140 in the shaving direction x. The second bearing axis may be located proximate the skin-contacting side 110 (and/or shaving plane SP). Due to the location of common bearing axis BA, first bearing axis or second bearing axis, a shaving performance can be improved.

As shown, e.g., in FIG. 1D, the razor head 10 may further comprise a protecting cover 300 configured to be releasably attached to the razor head 10. The razor head 10 can be inserted into a cavity of the protecting cover 300. The protecting cover 300 can cover cutting members 170a-d which may lead to increased safety for a user when coupling the razor head 10 to the connecting adapter 20 and/or to the razor handle 30.

As shown, e.g., in FIGS. 1A to 1D, the razor head 10 further comprises a connecting adapter 20a, 20b, wherein the coupling section 200 is releasably coupled to the connecting adapter 20a, 20b via a pivotable coupling, more specifically via the first and/or the second bearing mechanisms 210, 220. In other embodiments (not shown), the razor head 10 may be coupled to the connecting adapter 20a, 20b via a non-pivotable coupling. The connecting adapter 20a, 20b is pivotable about bearing axis BA with respect to the coupling section 200. However, it may alternatively be defined that the razor head 10 is pivotable about bearing axis BA with respect to the connecting adapter 20a, 20b. In embodiments, the connecting adapter 20b may be decoupled from the first bearing mechanism 210 by a bending and/or pivoting operation. In an example, the connecting adapter 20b may be pivoted towards the geometric center such that the connecting adapter 20b may be released by the second walls 204. The same may apply for decoupling the connecting adapter 20a from the second bearing mechanism 220. In another embodiment, the connecting adapter 20a may be decoupled from the second bearing mechanism 220 by pivoting the connecting adapter 20a to the most possible extent and by applying a releasing force that extends a retention force. However, other embodiments of decoupling the connecting adapter 20a, 20b from first and/or second bearing mechanisms 210, 220 may include positively locking and/or non-positively locking mechanisms, e.g., hinge mechanisms or bending mechanisms.

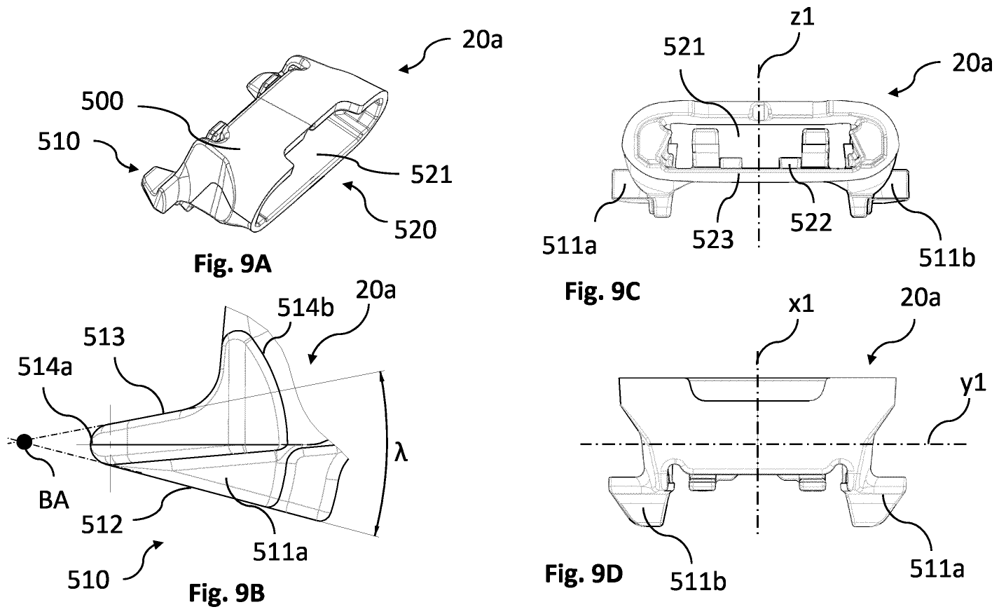

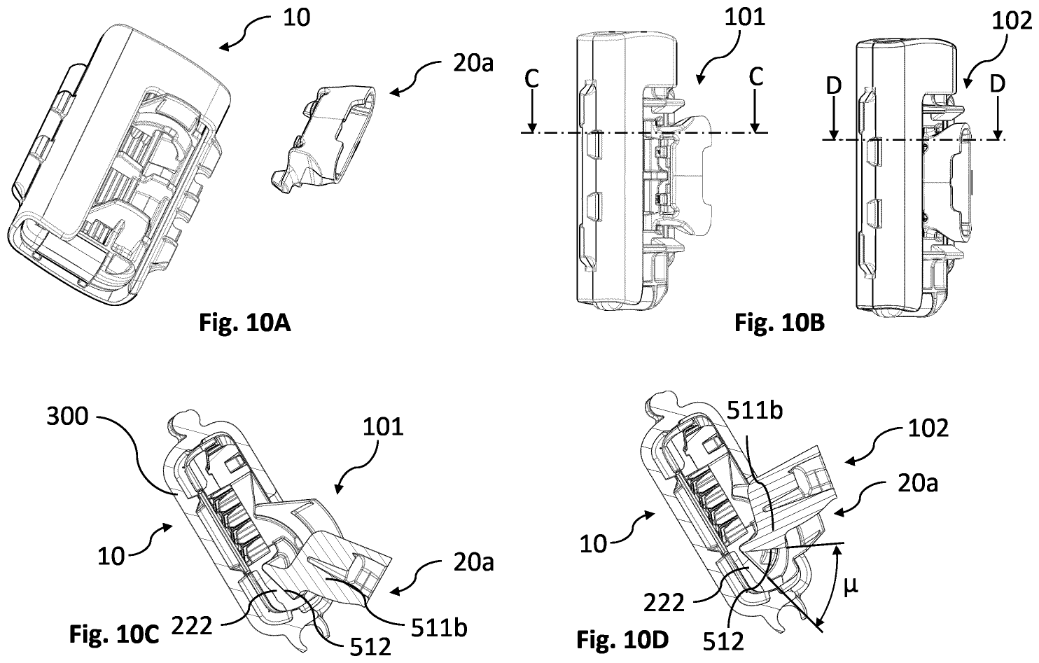

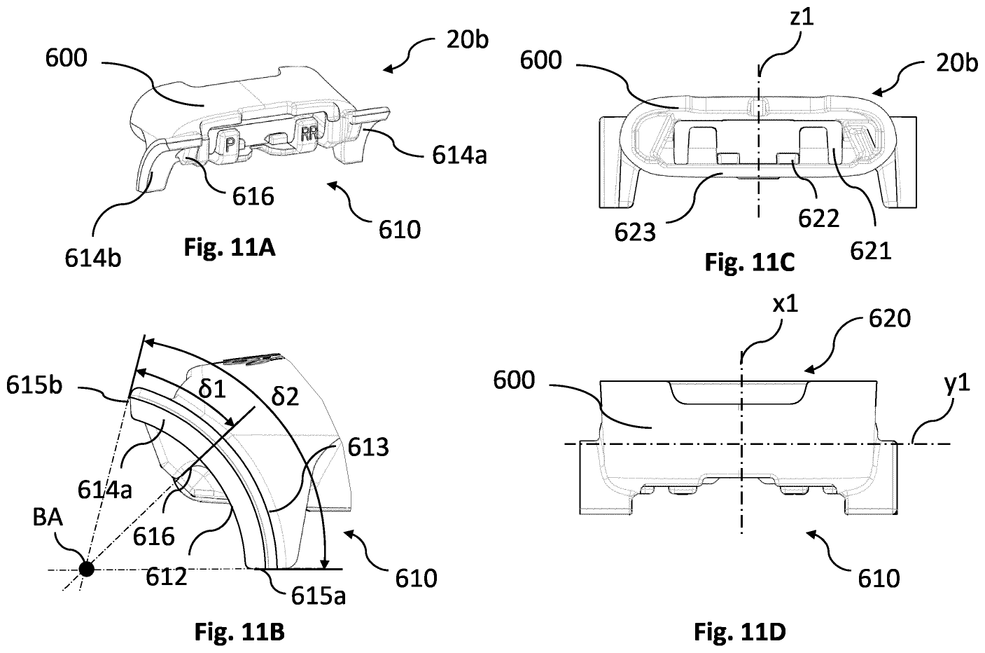

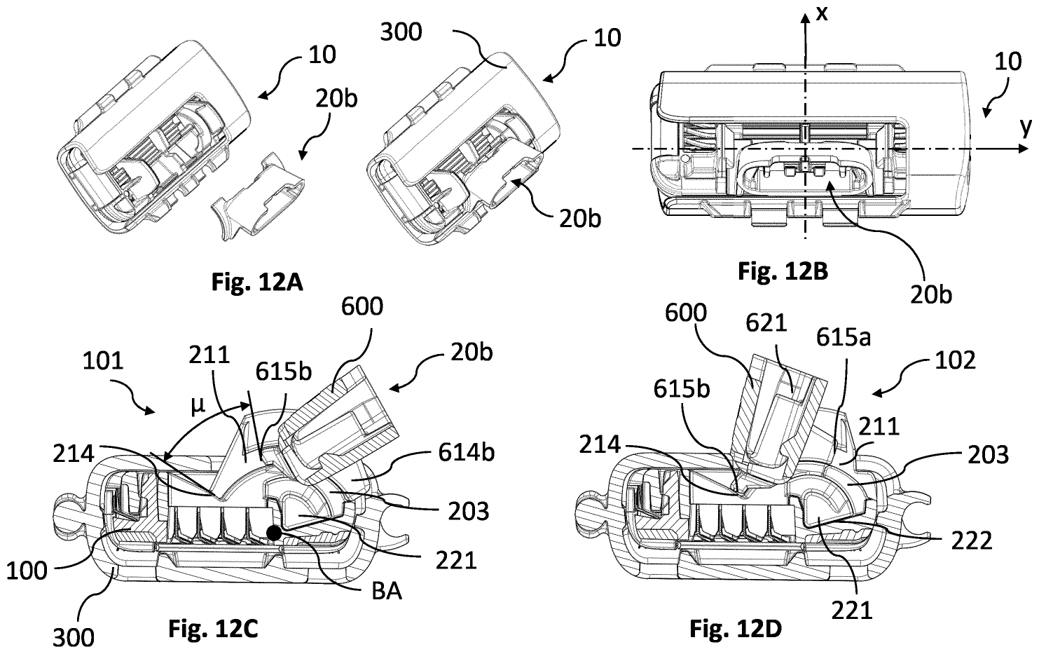

FIGS. 9A to 12D are schematic views of a connecting adapter 20a, 20b according to a first and a second embodiment. The connecting adapter 20a as shown in FIGS. 9A to 10D (first embodiment) can be coupled to the razor head 10 via the second bearing mechanism 220 and the connecting adapter 20b as shown in FIGS. 11A to 12D (second embodiment) can be coupled to the razor head via the first bearing mechanism 210. As already stated above, due to the functionally different first and second bearing mechanisms 210, 220 arranged in the same razor head 10, the razor head 10 can be coupled to different razor handles 30 and/or connecting adapters 20a, 20b.

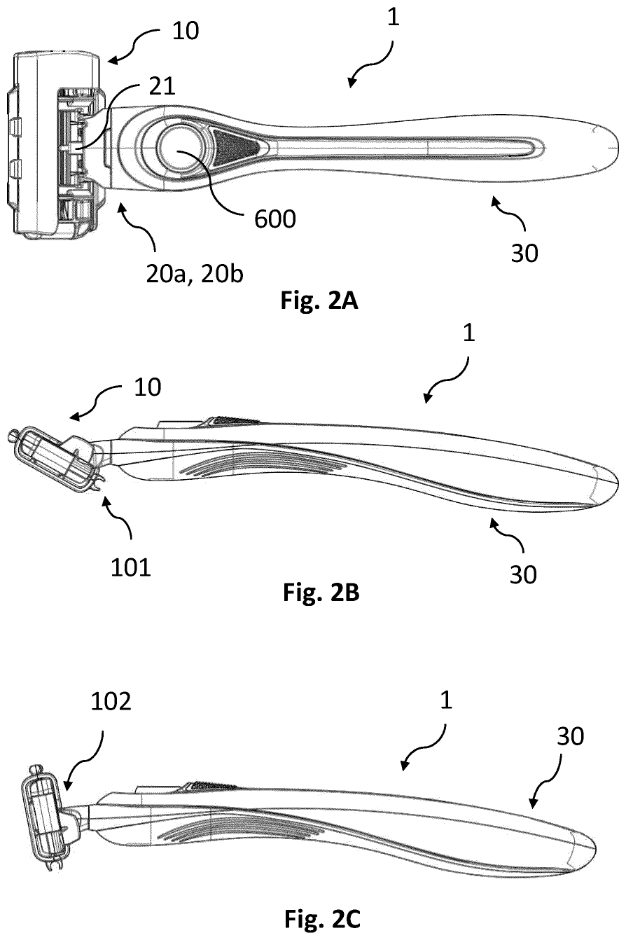

Referring to FIGS. 2, 10B to 10D and 12B to 12D, the connecting adapter 20a, 20b is pivotable between a first position 101 referring to a rest position and at least one second position 102 referring to a pivoted position. Starting from the first position 101, the connecting adapter 20a, 20b may be pivotable in a pivoting angle range of from 0°<μ≤50°, more specifically wherein the connecting adapter 20 may be pivotable in one direction, e.g., from a position proximate the leading edge 130 towards the trailing edge 140. In another embodiment, starting from the first position 101, the connecting adapter 20a, 20b may be pivotable in a pivoting angle range of from −25°≤μ≤+25°, more specifically wherein the connecting adapter 20a, 20b may be pivotable in two directions, e.g., in the direction towards the leading edge 130 and/or towards the trailing edge 140. Although the at least one second position 102 may be described above as an end position, it should be noted that during a shaving operation it may also be possible to pivot the connecting adapter 20a, 20b to intermediate positions.

As shown in FIGS. 9A to 9D and 11A to 11D, the connecting adapter 20a, 20b comprises a body portion 500, 600 having a first connecting portion 510, 610 arranged at a first end of the connecting body 500, 600, more specifically wherein the first connecting portion 510, 610 is configured to be coupled to the coupling section 200, in particular to the first bearing mechanism 210 and/or to the second bearing mechanism 220. The connecting adapter 20a, 20b comprises a longitudinal axis x1 and a perpendicular axis y1 that is perpendicular to the longitudinal axis x1, both extending through the geometric center of the connecting adapter 20a, 20b.

In embodiments, the body portion 500, 600 can have a second connecting portion 520, 620 provided on an end of the body portion 500, 600 opposite the first connecting portion 510, 610, wherein the second connecting portion 520, 620 may be configured to be coupled to a razor handle 30. However, the second connecting portion 520, 620 may only be provided in case the connecting adapter 20a, 20b is a separate component with respect to the razor handle 30. In other embodiments, the connecting adapter 20a, 20b may be integrally formed with the razor handle 30 such that the second connecting portion 520, 620 may be omitted. The second connecting portion 520, 620 may further comprise an opening 521, 621 configured to receive a first end 31 of a razor handle 30. The connecting adapter 20a, 20b may be coupled to the razor handle 30 and/or to the razor head 10 by positive locking or non-positive locking. In embodiments, the opening 521, 621 can comprises at least one detent 522, 622 provided on a wall 523, 623 of the opening 521, 621. In an embodiment, the opening 521, 621 may extend through the body portion 500, 600 in the direction of the longitudinal axis x1. The detents 522, 622 may be configured to be received by recesses being provided on the first end 31 of the razor handle 30 and having a complementary shape. In other embodiments, the recesses and the detents 522, 622 may be swapped.

As indicated in FIG. 1B, the razor handle 30 can comprise a retention and/or release mechanism 700 configured to couple the razor head 10 to the razor handle 30 and/or to decouple the razor head 10 from the razor handle 30. More specifically, in case the connecting adapter 20a, 20b is provided as a separate component with respect to the razor handle 30, the retention and/or release mechanism 700 may be configured to decouple the connecting adapter 20a, 20b and/or the razor head 10 from the razor handle 30. The retention and/or release mechanism 700 may include a switch (or a button), which can be operated by a user from a first switch position to a second switch position, thereby decoupling the razor head 10, and/or the connecting adapter 20, from the razor handle 30. The retention and/or release mechanism 700 can comprise at least one translatable member provided at the first end 31 of the razor handle 30. When a user operates the button, the translatable members can project substantially along a longitudinal axis of the razor handle 30, thereby applying a force on the back side of the razor head 10, or an inner wall of the connecting adapter 20a, 20b, to decouple the razor head 10 and/or the connecting adapter 20a, 20b from the razor handle 30.

As indicated in FIGS. 1C and 2A, the connecting adapter 20a, 20b can comprise a biasing element 21 configured to bias the connecting adapter 20a, 20b with respect to the coupling section 200 about the bearing axis BA. The biasing element 21 may engage with camming surface 206. In embodiments, wherein the connecting adapter 20a, 20b is a separate component and can be releasably coupled to the razor handle 30, the biasing element 21 can also be provided in the razor handle 30. In this case, and when coupled to the razor handle 30, the biasing element 21 may project through opening 521, 621 provided in the connecting adapter 20a, 20b in the longitudinal direction x1, such that the biasing element can engage with the camming surface 206.

The biasing element 21 can be a spring biased plunger translatable in the direction of longitudinal axis x1 of the connecting adapter 20a, 20b, more specifically wherein the biasing element 21 may comprise a cam follower adapted to engage with the camming surface 206. In other words, the cam follower may be adapted to contact and/or slide over the camming surface 206. The biasing element 21 can be configured to urge the razor head 10 to the first position 101, more specifically when the razor head 10 is coupled to the connecting adapter 20a, 20b. As already mentioned above, the first position 101 refers to a rest position of the razor head 10. More detailed, the biasing element 21 may urge the camming surface 206 and return the razor head 10 to the rest position. When the connecting adapter 20a, 20b is not pivoted with respect to the coupling section 200, e.g., when the razor 1 is not used (and the razor head 10 does not contact a user's skin surface) or contacts the skin in the first position 101, the biasing element 21 may urge the razor head 10 to the first position 101. In this case, the plunger may translate to the most possible extent in the direction of the longitudinal axis x1. When the razor head 10 is pivoted during a shaving operation, the biasing element 21 may be pushed into the connecting adapter 20 (and/or razor handle 30).

The connecting adapter 20a according to a first embodiment is shown in FIGS. 9A to 10D. The first connecting portion 510 comprises a pair of bearing pins 511a, 511b configured to be inserted into the pair of bearing cavities 221. Each bearing pin of the pair of bearing pins 511a, 511b extends outwardly parallel to the perpendicular axis y1 and parallel to the longitudinal axis x1 from the body portion 500. In the embodiment shown in FIG. 9B, each of the bearing pins 511a, 511b can be V-shaped viewed in a plane x1-z1 defined by the longitudinal axis x1 and a vertical axis z1 that is perpendicular to the longitudinal axis x1 and the perpendicular axis y1. Each of the bearing pins 511a, 511b comprises a bottom side 512 and a top side 513, wherein the V-shape of each of the bearing pins 511a, 511b may include an angle λ. The pivoting angle μ as described above may be measured between the bottom side 512 and the bottom wall 222 or between the top side 513 and the side wall 223. In the first position 101, the bottom side 512 may be parallel to the bottom wall 222 and/or may bear against the bottom wall 222. Additionally or alternatively, in the at least one second position 102, the bottom side 512 may lie under pivoting angle μ measured between bottom wall 222 and the bottom side 512. In other words, the bottom side 512 and the bottom wall 222 together can form a first stop and the top side 513 and the side wall 223 can form a second stop.

Each of the bearing pins 511a, 511b comprises a first arc-shaped bearing pin surface 514a and a second arc-shaped bearing pin surface 514b opposite the first arc-shaped bearing pin surface 514a. With respect to the connecting body 500 (more specifically viewed from the geometric center of the connecting body 500), the first arc-shaped bearing pin surface 514a may have a convex shape and the second arc-shaped bearing pin surface 514b may have a concave shape. When the pair of bearing pins 511a, 511b are inserted into the pair of bearing cavities 221, the first arc-shaped bearing pin surface 514a may contact and/or bear against the fourth arc-shaped bearing surface 225 and the second arc-shaped bearing pin surface 514b may contact and/or bear against the third arc-shaped bearing surface 224.

The connecting adapter 20b according to a second embodiment is shown in FIGS. 11A to 12D. In this embodiment, the first connecting portion 610 comprises a pair of arc-shaped bearings 614a, 614b configured to be inserted into the pair of arc-shaped bearing sections 211. Each arc-shaped bearing of the pair of arc-shaped bearings 614a, 614b extends outwardly parallel to the perpendicular axis y1 from the body portion 600. The arc-shape of the pair of arc-shaped bearings 614a, 614b may extend away from the body portion 600. In other words, the pair of arc-shaped bearings 614a, 614b may have a concave shape with respect to a geometric center of the body portion 600. Each arc-shaped bearing of the pair of arc-shaped bearings 614a, 614b has a bottom side 612, a top side 613, a first side edge 615a and a second side edge 615b. With respect to the connecting body 600 (more specifically to the geometric center of the connecting body 600), the bottom side 612 and/or the top side (613) may have a concave shape. When the pair of arc-shaped bearings 614a, 614b are inserted into the pair of arc-shaped bearing sections 211, the bottom side 612 may contact and/or bear against the first arc-shaped bearing surface 212 and the top side 613 may contact and/or bear against the second arc-shaped bearing surface 613. The bottom side 612 may be arc-shaped and defined by a radius of about 4.0 mm to 7.0 mm, more specifically of about 5.0 mm to 6.0 mm, in particular of about 5.2 mm to 5.8 mm. The top side 613 may be arc-shaped and defined by a radius of about 5.0 mm to 8.0 mm, more specifically of about 6.0 mm to 7.0 mm, in particular of about 6.2 mm to 6.9 mm.

In embodiments, the connecting adapter 20b can comprise an adapter shoulder 616 configured to bear against shoulder 208 of the coupling section 200, more specifically in the first position 101 when the razor head 10 is pivotable only in one direction. In the at least one second position (102), the second side edge 615b may contact and/or bear against stopper wall 214. In embodiments, the first position 101 may be between the at least one second position 102 comprising a first end position and a second end position. In this case, the connecting adapter 20b can be pivoted in both directions, more specifically towards the leading edge 130 and/or the trailing edge 140 up to a pivoting angle of 25°. In the first end position proximate the leading edge 130, the connecting adapter 20b, more specifically the adapter shoulder 616 can contact and/or bear against shoulder 208. In the second end position proximate the trailing edge 140, the second side edge 615b can contact and/or bear against the stopper wall 214. The pivoting range angle μ may be measured between the stopper wall 214 and the second side edge 615b. In embodiments, the pivoting range angle μ may also be measured between the bottom wall 222 and the first side edge 615a.

In the following, examples are described of how the pivoting angle range μ may be determined with respect to first and second bearing mechanisms 210, 220.

Referring to FIG. 7B and in an example, the first bearing mechanism 210 comprises a first pivoting range γ measured with respect to bearing axis BA. The first pivoting range γ may be measured between shoulder 208 and stopper wall 214. In this case, the first arc-shaped bearing surface 212 may extend over a circumferential area that is equal to or larger than the first pivoting range γ. The first pivoting range γ is dependent on the specific arrangement of shoulder 208 and stopper wall 214, more specifically to each other. In case the connecting adapter 20b is coupled to the razor head 10 via the first bearing mechanism 210 as shown in FIGS. 12C and 12D, the pivoting angle range μ of the razor head 10 with respect to the connecting adapter 20b may result from the difference between an angle δ1 referring to a circumferential area measured between adapter shoulder 616 and second side edge 615b (see, e.g., FIG. 11B) and with respect to bearing axis BA, and the first pivoting range γ. For example, the first pivoting range γ may be designed to be 80° and angle δ1 may be designed to be 30°. The resulting pivoting angle range μ may then be 50°. However, it should be understood that other designs of the respective components and angles are also possible.

In another example, shoulder 208 and/or shoulder 616 may be omitted. In this embodiment, the connecting adapter 20b may contact and/or bear against a portion of the back side 120, proximate the leading edge 130, with its first side edge 615a in the first position 101 or in the at least one second position 102, more specifically in the first end position (see, e.g., FIG. 12C). Furthermore, the connecting adapter 20b may contact and/or bear against stopper wall 214 with its second side edge 615b in the at least one second position 102, more specifically the second end position (see, e.g., FIG. 12D). In this case the first bearing mechanism 210 may comprise a third pivoting range γ+α, measured between bottom wall 222 and stopper wall 214 with respect to bearing axis BA. In this case, the first wall 203 and/or the first arc-shaped bearing surface 212 may extend over a circumferential area that is equal to the third pivoting range γ+α. When the connecting adapter 20b is coupled to the razor head 10 via the first bearing mechanism 210 as shown in FIGS. 12C and 12D, the pivoting angle range μ of the razor head 10 with respect to the connecting adapter 20b may result from the difference between an angle δ2 referring to a circumferential area over which the pair of arc-shaped bearings 614a, 614b extend, measured between first and second side edges 615a, 615b with respect to bearing axis BA (see, e.g., FIG. 11B), and the third pivoting range γ+α. For example, the third pivoting range γ+α may be designed to be 130° and angle δ2 may be designed to be 80°. The resulting pivoting angle range may then be 50°. However, it should be understood that other designs of the respective components and angles are also possible.

Referring to FIG. 7B, the second bearing mechanism 220 comprises a second pivoting range measured with respect to bearing axis BA. The second pivoting range R may be measured between bottom wall 222 and side wall 223. In this case, the third arc-shaped bearing surface 224 may extend over a circumferential area that is equal to or larger than the second pivoting range β. The second pivoting range β is dependent on the specific arrangement of bottom wall 222 and side wall 223, more specifically to each other. In case the connecting adapter 20a is coupled to the razor head 10 via the second bearing mechanism 220 as shown in FIGS. 10C and 10D, the pivoting angle range μ of the razor head 10 with respect to the connecting adapter 20a may result from the difference between angles λ (see, e.g., FIG. 9B, angle of the V-shape of the bearing pins 511a, 511b) and the second pivoting range β. For example, the second pivoting range β may be designed to be 75° and angle λ may be designed to be 25°. The resulting pivoting angle range μ may then be 50°. However, it should be understood that other designs of the respective components and angles are also possible.

According to another aspect of the present disclosure, a kit of parts is provided (not shown in the Figs.). The kit of parts comprises a razor cartridge holder comprising a plurality of razor heads 10 according to any one of the embodiments described above. In an embodiment, the kit of parts may further comprise a razor handle 30. More specifically, the kit of parts may comprise the razor head 10 and at least one connecting adapter 20a, 20b according to the first and/or second embodiment as described above. However, it should be noted that the connecting adapter 20a, 20b may be a separate component with respect to the razor handle 30, or may be integrally formed with the razor handle 30.

According to a fourth aspect of the present disclosure, a method of assembling a razor 1 is provided. The method comprises the steps of providing a razor handle 30, providing a razor head 10 according to any one of the embodiments as described above, and coupling the razor handle 30 to the razor head 10. In embodiments, the connecting adapter 20a, 20b may be integrally formed with the razor handle 30. Coupling the razor handle 30 to the razor head 10 may comprise coupling the razor handle 30 to the coupling section 200, more specifically to the first bearing mechanism 210 or to the second bearing mechanism 220, via the connecting adapter 20a, 20b.

In other embodiments, the connecting adapter 20a, 20b may be a separate component. Coupling the razor handle 30 to the razor head 20 may comprise coupling the connecting adapter 20a, 20b to the coupling section 200, more specifically to the first bearing mechanism 210 or to the second bearing mechanism 220, and coupling the connecting adapter 20a, 20b to the razor handle 30. The razor 1 and/or razor head 10 may be designed according to any one of the above-described embodiments.

Although the present invention has been described above and is defined in the attached claims, it should be understood that the invention may alternatively be defined in accordance with the following embodiments:
1. A razor head (10), comprising:
   a frame (100) having a skin-contacting side (110) and a back side (120) opposite the skin-contacting side (110), wherein a coupling section (200) is arranged on the back side (120), wherein the coupling section (200) is configured to couple the razor head (10) to a razor handle (30),
   characterized in that the coupling section (200) comprises a first bearing mechanism (210) and a second bearing mechanism (220) that are functionally different.
2. The razor head (10) according to embodiment 1, wherein at least one of the first and the second bearing mechanisms (210, 220) is a pivoting mechanism, more specifically, wherein each of the first and second bearing mechanisms (210, 220) is a pivoting mechanism.
3. The razor head (10) according to embodiment 1 or embodiment 2, wherein the razor head (10) comprises a shaving direction (x), a perpendicular direction (y) which is perpendicular to the shaving direction (x), and a vertical direction (z) which is perpendicular to the shaving direction (x) and the perpendicular direction (y).
4. The razor head (10) according to any one of the preceding embodiments, wherein the frame (100) further comprises a leading longitudinal member defining a leading edge (130) and a trailing longitudinal member defining a trailing edge (140), more specifically wherein a shaving plane (SP) is defined on the skin-contacting side of the frame (100).
5. The razor head (10) according to any one of the preceding embodiments, wherein the first bearing mechanism (210) comprises a pair of arc-shaped bearing sections (211).
6. The razor head (10) according to any one of the preceding embodiments, wherein the second bearing mechanism (220) comprises a pair of bearing cavities (221).
7. The razor head (10) according to embodiments 5 and 6, wherein the pair of arc-shaped bearing sections (211) and/or the pair of bearing cavities (221) extend parallel to the perpendicular direction (y), more specifically wherein the pair of arc-shaped bearing sections (211) and/or the pair of bearing cavities (221) are oriented towards the geometric center of the razor head (10) in the perpendicular direction (y), respectively.
8. The razor head (10) according to any one of the preceding embodiments, wherein the coupling section (200) comprises a pair of first walls (203) which are arc-shaped, more specifically wherein the pair of first walls (203) are separated and/or aligned to each other with respect to the perpendicular direction (y).
9. The razor head (10) according to embodiment 8, when dependent on embodiment 3, wherein the pair of first walls (203) extend from a position proximate a side portion (150) of the frame (100) in the perpendicular direction (y) towards the geometric center of the razor head (10), respectively.
10. The razor head (10) according to embodiment 8 or embodiment 9, wherein the pair of first walls (203) extend over a circumferential area with respect to a bearing axis (BA) that extends parallel to the perpendicular direction (y).
11. The razor head (10) according to any one of embodiments 8 to 10, wherein the pair of bearing cavities (221) are formed between the back side (120) and the pair of first walls (203), respectively.
12. The razor head (10) according to any one of embodiments 8 to 11, wherein the pair of first walls (203) comprise a first arc-shaped bearing surface (212) that is oriented substantially in the vertical direction (z), respectively.
13. The razor head (10) according to embodiment 12, wherein the first arc-shaped bearing surface (212) is defined by a radius of about 4.0 mm to 7.0 mm, more specifically of about 5.0 mm to 6.0 mm, in particular of about 5.2 mm to 5.8 mm.
14. The razor head (10) according to embodiment 8 to 13, wherein the pair of first walls (203) each comprise a stopper wall (214) that extends from the first arc-shaped bearing surface (212) at a position proximate the geometric center of the razor head (10) towards the trailing edge (140) and the back side (120), more specifically under an angle with respect to the shaving plane (SP).
15. The razor head (10) according to any one of embodiments 8 to 14, wherein the pair of first walls (203) each comprise a third arc-shaped bearing surface (224) that is oriented towards the pair of bearing cavities (221).
16. The razor head (10) according to embodiment 15, wherein the third arc-shaped bearing surface (224) is defined by a radius of about 2.0 mm to 4.0 mm, more specifically of about 2.5 mm to 3.5 mm.
17. The razor head (10) according to any one of the preceding embodiments, wherein the coupling section (200) comprises at least one protrusion (202) extending from the back side (120) in the vertical direction (z).
18. The razor head (10) according to any one of the preceding embodiments, wherein the coupling section (200) comprises two protrusions (202a, 202b) extending from the back side (120) in the vertical direction (z), wherein the two protrusions (202a, 202b) are separated and/or aligned to each other with respect to the perpendicular direction (y).
19. The razor head (10) according to embodiment 18, wherein the first bearing mechanism (210) and the second bearing mechanism (220) are formed between the two protrusions (202a, 202b) in the perpendicular direction (y).
20. The razor head (10) according to embodiment 18 or embodiment 19, when dependent on embodiment 8, wherein the pair of first walls (203) are arranged adjacent and between the two protrusions (202a, 202b), respectively.
21. The razor head (10) according to any one of embodiments 14 to 17, wherein in the vertical direction (z) and from the back side (120), the coupling section (200) comprises the second bearing mechanism (220) followed by the first bearing mechanism (210).
22. The razor head (10) according to any one of embodiments 18 to 21, wherein each of the protrusions (202a, 202b) comprises a second wall (204) extending proximal an end (205) of the respective protrusion (202a, 202b) in the perpendicular direction (y) towards a geometric center of the razor head (10), wherein the second wall (204) defines a second arc-shaped bearing surface (213).
23. The razor head (10) according to embodiment 22, wherein the second arc-shaped bearing surface (213) is defined by a radius of about 5.0 mm to 8.0 mm, more specifically of about 6.0 mm to 7.0 mm, in particular of about 6.2 mm to 6.9 mm.
24. The razor head (10) according to embodiments 22 and 23, wherein the first arc-shaped bearing surface (212) extends over a circumferential area that is larger than a circumferential area over which the second arc-shaped bearing surface (213) extends.
25. The razor head (10) according to any one of embodiments 22 to 24, wherein starting from a position on the back side (120) in the vertical direction (z), coupling section (200) comprises the pair of bearing cavities (221), followed by the pair of first walls (203), followed by the pair of arc-shaped bearing sections (211), followed by the pair of second walls (204).
26. The razor head (10) according to any one of embodiments 22 to 25, wherein the second arc-shaped bearing surface (213) extends parallel to the first arc-shaped bearing surface (212) and/or to the third arc-shaped bearing surface (224).
27. The razor head (10) according to any one of embodiments 22 to 26, wherein the pair of arc-shaped bearing sections (211) are defined between the pair of first walls (203) and the pair of second walls (204), more specifically between the first arc-shaped bearing surface (212) and the second arc-shaped bearing surface (213).
28. The razor head (10) according to any one of embodiments 22 to 27, wherein the pair of first walls (203) each comprise a first length (l1) and wherein the pair of second walls (204) each comprise a second length (l2) measured parallel to the perpendicular direction (y), wherein the first length (l1) is larger than the second length (l2).
29. The razor head (10) according to embodiment 28, wherein the pair of first walls (203) each comprise a first wall portion (203a) having the first length (l1) and a second wall portion (203b) having a third length (l3), more specifically wherein the first length (l1) is larger than the third length (l3).
30. The razor head (10) according to any one of embodiments 22 to 29, wherein, with respect to the shaving plane (SP), the first arc-shaped bearing surface (212) and/or the second arc-shaped bearing surface (213) have a convex shape.
31. The razor head (10) according to any one of embodiments 15 to 30, wherein the pair of bearing cavities (221) each comprise a fourth arc-shaped bearing surface (225) opposite the third arc-shaped bearing surface (224), more specifically wherein, with respect to the shaving plane (SP), the third arc-shaped bearing surface (224) has a convex shape and wherein the fourth arc-shaped bearing surface (225) has a concave shape.
32. The razor head (10) according to any one of embodiments 6 to 31, wherein each bearing cavity (221) comprises a bottom wall (222) extending from a position proximate the leading edge (130) towards the geometric center of the razor head (10) under an angle (δ), measured between the bottom wall (222) and the shaving plane (SP), and wherein the bottom wall (222) extends in the perpendicular direction (y) towards the geometric center of the razor head (10).
33. The razor head (10) according to embodiment 32, wherein each bearing cavity (221) comprises a side wall (223) extending from the bottom wall (222) at a position proximate the geometric center of the razor head (10) substantially in the vertical direction (z), and wherein the side wall (223) extends in the perpendicular direction (y) towards the geometric center of the razor head (10).
34. The razor head (10) according to embodiment 33, wherein each bearing cavity (221) is defined by the first wall (203), more specifically by the third arc-shaped bearing surface (224), by the fourth arc-shaped bearing surface (225), by the bottom wall (222) and the side wall (223).
35. The razor head (10) according to any one of the preceding embodiments, wherein the coupling section (200) comprises a camming section (201).
36. The razor head (10) according to embodiment 35, wherein the camming section (201) comprises a camming wall (207) extending from the back side (120) in the vertical direction (z), wherein the camming wall (207) comprises a camming surface (206) that extends parallel to the perpendicular direction (y).
37. The razor head (10) according to any one of embodiments 4 to 36, wherein the trailing longitudinal member comprises a trimming assembly (400) provided on the trailing edge (140).
38. The razor head (10) according to any one of the preceding embodiments, further comprising a protecting cover (300) configured to be releasably attached to the razor head (10).
39. The razor head (10) according to any one of the preceding embodiments, further comprising a connecting adapter (20a, 20b), wherein the coupling section (200) is releasably coupled to the connecting adapter (20a, 20b) via a pivotable or non-pivotable coupling, more specifically via the first and/or the second bearing mechanisms (210, 220).
40. The razor head (10) according to embodiment 39, wherein the connecting adapter (20a, 20b) is pivotable about bearing axis (BA) with respect to the coupling section (200).
41. The razor head (10) according to embodiment 39 or embodiment 40, wherein the connecting adapter (20a, 20b) is pivotable between a first position (101) referring to a rest position and at least one second position (102) referring to a pivoted position.
42. The razor head (10) according to embodiment 41, wherein, starting from the first position (101), the connecting adapter (20a, 20b) is pivotable in a pivoting angle range of from 0°≤μ≤50°, more specifically wherein the connecting adapter (20) is pivotable in one direction.
43. The razor head (10) according to embodiment 41, wherein, starting from the first position (101), the connecting adapter (20a, 20b) is pivotable in a pivoting angle range of from −25°≤μ≤+25°, more specifically wherein the connecting adapter (20a, 20b) is pivotable in two directions.
44. The razor head (10) according to any one of embodiments 39 to 43, wherein the connecting adapter (20a, 20b) comprises a biasing element (21) configured to bias the connecting adapter (20a, 20b) with respect to the coupling section (200) about the bearing axis (BA).
45. The razor head (10) according to embodiment 44, wherein the biasing element (21) is a spring biased plunger translatable in the direction of longitudinal axis (x1) of the connecting adapter (20a, 20b), more specifically wherein the biasing element (21) comprises a cam follower adapted to engage with the camming surface (206).
46. The razor head (10) according to embodiment 44 or embodiment 45, wherein the biasing element (21) is configured to urge the razor head (10) to the first position (101).
47. The razor head (10) according to any one of embodiments 39 to 46, wherein the connecting adapter (20a, 20b) comprises a body portion (500, 600) having a first connecting portion (510, 610) arranged at a first end of the connecting body (500, 600), more specifically wherein the first connecting portion (510, 610) is configured to be coupled to the coupling section (200), in particular to the first bearing mechanism (210) and/or to the second bearing mechanism (220).
48. The razor head (10) according to embodiment 47, wherein the body portion (500, 600) has a second connecting portion (520, 620) provided on an end of the body portion (500, 600) opposite the first connecting portion (510, 610), wherein the second connecting portion (520, 620) is configured to be coupled to a razor handle (30).
49. The razor head (10) according to embodiment 48, wherein the second connecting portion (520, 620) comprises an opening (521, 621) configured to receive a first end (31) of a razor handle (30).
50. The razor head (10) according to embodiment 49, wherein the opening (521, 621) comprises at least one detent (522, 622) provided on a wall (523, 623) of the opening (521, 621).
51. The razor head (10) according to any one of embodiments 39 to 50, wherein the connecting adapter (20a, 20b) comprises a longitudinal axis (x1) and a perpendicular axis (y1) that is perpendicular to the longitudinal axis (x1), both extending through the geometric center of the connecting adapter (20a, 20b).
52. The razor head (10) according to any one of embodiments 47 to 51, wherein the first connecting portion (510) comprises a pair of bearing pins (511a, 511b) configured to be inserted into the pair of bearing cavities (221).
53. The razor head (10) according to embodiment 52, wherein each bearing pin of the pair of bearing pins (511a, 511b) extends outwardly parallel to the perpendicular axis (y1) and parallel to the longitudinal axis (x1) from the body portion (500).
54. The razor head (10) according to embodiment 52 or embodiment 53, wherein each of the bearing pins (511a, 511b) is V-shaped viewed in a plane (xl-z1) defined by the longitudinal axis (x1) and a vertical axis (z1) that is perpendicular to the longitudinal axis (x1) and the perpendicular axis (y1).
55. The razor head (10) according to embodiment 54, wherein each of the bearing pins (511a, 511b) comprises a bottom side (512) and a top side (513), wherein the V-shape of each of the bearing pins (511a, 511b) includes an angle (λ).
56. The razor head (10) according to embodiment 55, wherein the pivoting angle (μ) is measured between the bottom side (512) and the bottom wall (222) and/or between the top side (513) and the side wall (223).
57. The razor head (10) according to embodiment 55 or embodiment 56 and embodiment 41, wherein in the first position (101), the bottom side (512) is parallel to the bottom wall (222) and/or bears against the bottom wall (222), and/or wherein, in the at least one second position (102), the bottom side (512) lies under pivoting angle (μ) measured between bottom wall (222) and the bottom side (512).
58. The razor head (10) according to any one of embodiments 52 to 57, wherein each of the bearing pins (511a, 511b) comprises a first arc-shaped bearing pin surface (514a) and a second arc-shaped bearing pin surface (514b) opposite the first arc-shaped bearing pin surface (514a).
59. The razor head (10) according to embodiment 58, wherein, with respect to the connecting body (500), the first arc-shaped bearing pin surface (514a) has a convex shape and the second arc-shaped bearing pin surface (514b) has a concave shape.
60. The razor head (10) according to embodiment 58 or embodiment 59, wherein, when the pair of bearing pins (511a, 511b) are inserted into the pair of bearing cavities (221), the first arc-shaped bearing pin surface (514a) bears against the fourth arc-shaped bearing surface (225) and the second arc-shaped bearing pin surface (514b) bears against the third arc-shaped bearing surface (224).
61. The razor head (10) according to any one of embodiments 39 to 51, wherein the first connecting portion (610) comprises a pair of arc-shaped bearings (614a, 614b) configured to be inserted into the pair of arc-shaped bearing sections (211).
62. The razor head (10) according to embodiment 61, wherein each arc-shaped bearing of the pair of arc-shaped bearings (614a, 614b) extends outwardly parallel to the perpendicular axis (y1) from the body portion (600).
63. The razor head (10) according to embodiment 61 or embodiment 62, wherein each arc-shaped bearing of the pair of arc-shaped bearings (614a, 614b) has a bottom side (612), a top side (613), a first side edge (615a) and a second side edge (615b).
64. The razor head (10) according to embodiment 63, wherein, with respect to the connecting body (600), the bottom side (612) has a concave shape and the top side (613) has a concave shape.
65. The razor head (10) according to embodiment 63 or embodiment 64, wherein, when the pair of arc-shaped bearings (614a, 614b) are inserted into the pair of arc-shaped bearing sections (211), the bottom side (612) bears against the first arc-shaped bearing surface (212) and the top side (613) bears against the second arc-shaped bearing surface (613).
66. The razor head (10) according to any one of embodiments 41 to 65, wherein the connecting adapter (20b) comprises an adapter shoulder (616) configured to bear against shoulder (208) of the coupling section (200), more specifically in the first position (101).
67. The razor head (10) according to any one of embodiments 63 to 66, wherein the bottom side (612) is arc-shaped and defined by a radius of about 4.0 mm to 7.0 mm, more specifically of about 5.0 mm to 6.0 mm, in particular of about 5.2 mm to 5.8 mm.
68. The razor head (10) according to any one of embodiments 63 to 67, wherein the top side (613) is arc-shaped and defined by a radius of about 5.0 mm to 8.0 mm, more specifically of about 6.0 mm to 7.0 mm, in particular of about 6.2 mm to 6.9 mm.
69. The razor head according to any one of embodiments 41 to 68, wherein in the at least one second position (102), the second side edge (615b) bears against the stopper wall (214).
70. The razor head (10) according to any one of embodiments 63 to 69, wherein a pivoting angle (μ) is measured between the stopper wall (214) and the second side edge (615b).
71. The razor head (10) according to any one of the preceding embodiments, wherein the frame (100) comprises a plurality of cutting member guides (160a-d) defining a plurality of cutting member support slots (161a-d), each cutting member support slot (161a-d) configured to accommodate a longitudinal cutting member (170a-d), and a plurality of longitudinal cutting members (170a-d), wherein each cutting member (170a-d) is disposed in a respective cutting member support slot (161a-d).
72. The razor head (10) according to embodiment 71, when dependent on embodiment 3, wherein the frame (100) comprises at least one C-shaped cutting member retainer (180) configured to be pushed onto a side portion (150) of the frame (100) in the perpendicular direction (y), wherein the at least one cutting member retainer (180) is configured to retain the plurality of cutting members (170) when inserted in the plurality of cutting member support slots.
73. A kit of parts, comprising:
   a razor cartridge holder comprising a plurality of razor heads (10) according to any one of the preceding embodiments.
74. The kit of parts according to embodiment 73, further comprising a razor handle (30).
75. A razor (1), comprising:
   a razor head (10) according to any one of embodiments 1 to 72, and
   a razor handle (30), wherein the razor head (10) is coupled to the razor handle (30).
76. The razor (1) according to embodiment 75, wherein the razor handle (30) is coupled to the razor head (10) via the connecting adapter (20a, 20b).
77. The razor (1) according to embodiment 76, wherein the connecting adapter (20a, 20b) is integrally formed with the razor handle (30).
78. The razor (1) according to embodiment 76, wherein the connecting adapter (20a, 20b) is releasably coupled to the razor handle (30).
79. The razor (1) according to any one of embodiments 75 to 78, wherein the razor handle (30) comprises a retention and/or release mechanism (700) configured to couple the razor head (10) to the razor handle (30) and/or to decouple the razor head (10) from the razor handle (30).
80. A method of assembling a razor (1), comprising the steps of:
   providing a razor handle (30),
   providing a razor head (10) according to any one of embodiments 1 to 72, and
   coupling the razor handle (30) to the razor head (10).
81. The method according to embodiment 80, wherein the connecting adapter (20a, 20b) is integrally formed with the razor handle (30), and wherein coupling the razor handle (30) to the razor head (10) comprises coupling the razor handle (30) to the coupling section (200), more specifically to the first bearing mechanism (210) or to the second bearing mechanism (220), via the connecting adapter (20a, 20b).
82. The method according to embodiment 80, wherein the connecting adapter (20a, 20b) is a separate component and wherein coupling the razor handle (30) to the razor head (20) comprises coupling the connecting adapter (20a, 20b) to the coupling section (200), more specifically to the first bearing mechanism (210) or to the second bearing mechanism (220), and coupling the connecting adapter (20a, 20b) to the razor handle (30).

### REFERENCE NUMERALS

x shaving direction 21 biasing element
y perpendicular direction 30 razor handle
z vertical direction 31 first end
x1 longitudinal axis 32 second end
y1 perpendicular axis 101 first position
z1 vertical axis 102 second position
SP shaving plane 100 frame
BA bearing axis 110 skin-contacting side
α circumferential area of first wall 120 back side
   portion 130 leading edge
β second pivoting range 140 trailing edge
γ first pivoting range 141 skin care element
μ pivoting angle range 150 side portion
δ angle between bottom wall and 160a-d cutting member guide
   shaving plane 161a-d cutting member support slot
δ1 angle between adapter shoulder and 170 cutting member
   second side edge 171 blade support
δ2 angle between first side edge and 172 blade
   second side edge 173 top portion
λ angle of V-shape 174 radius bent portion
l1 length of first wall 175 lower portion
l2 length of second wall 176 cutting edge
l3 length of second wall portion 170a-d cutting member
L1 length of connection portion 180 cutting member retainer
L2 total length of blade 190 guard member
L3 total length of cutting member 200 coupling section
L4 length of lower portion 201 camming section
L5 length of top portion 202 protrusion
H height of cutting member 202a protrusion
E exposure 202b protrusion
T1 thickness of blade 203 first wall
T2 thickness of blade support 203a first wall portion
A approach angle 203b second wall portion
1 razor 204 second wall
razor head 205 end of protrusion
20a connecting adapter 206 camming surface
20b connecting adapter 207 camming wall
208 shoulder of first wall 514b second arc-shaped bearing pin surface
210 first bearing mechanism 520 second connecting portion
211 arc-shaped bearing section 521 opening
212 first arc-shaped bearing surface 522 detent
213 second arc-shaped bearing surface 523 wall
214 stopper wall 600 body portion
220 second bearing mechanism 610 first connecting portion
221 bearing cavity 612 bottom side
222 bottom wall 613 top side
223 side wall 614a arc-shaped bearing
224 third arc-shaped bearing surface 614b arc-shaped bearing
300 protecting cover 615a first side edge
400 trimming assembly 615b second side edge
410 trimming cutting member 616 adapter shoulder
420 trimming cutting member support slot 620 second connecting portion
500 body portion 621 opening
510 first connecting portion 622 detent
511a bearing pin 623 wall
511b bearing pin
512 bottom side
513 top side
514a first arc-shaped bearing pin surface

1. A razor head, comprising:
a frame having a skin-contacting side and a back side opposite the skin-contacting side, wherein a coupling section is arranged on the back side, wherein the coupling section is configured to couple the razor head to a razor handle,
wherein the coupling section comprises a first bearing mechanism and a second bearing mechanism that are functionally different.

2. The razor head according to claim 1, wherein at least one of the first and the second bearing mechanisms is a pivoting mechanism, more specifically, wherein each of the first and second bearing mechanisms is a pivoting mechanism.

3. The razor head according to claim 1, wherein the first bearing mechanism comprises a pair of arc-shaped bearing sections and/or wherein the second bearing mechanism comprises a pair of bearing cavities.

4. The razor head according to claim 1, wherein the razor head comprises a shaving direction (x), a perpendicular direction (y) which is perpendicular to the shaving direction (x), and a vertical direction (z) which is perpendicular to the shaving direction (x) and the perpendicular direction (y),
wherein the coupling section comprises a pair of first walls which are arc-shaped, more specifically wherein the pair of first walls are separated and/or aligned to each other with respect to the perpendicular direction (y), in particular wherein the pair of bearing cavities are formed between the back side and the pair of first walls, respectively.

5. The razor head according to claim 4, wherein the pair of arc-shaped bearing sections and/or the pair of bearing cavities extend parallel to the perpendicular direction (y), wherein the pair of arc-shaped bearing sections and/or the pair of bearing cavities are oriented towards the geometric center of the razor head in the perpendicular direction (y), respectively.

6. The razor head according to claim 4, wherein the pair of first walls each comprise a third arc-shaped bearing surface that is oriented towards the pair of bearing cavities.

7. The razor head according to the claim 6 wherein the pair of bearing cavities comprise a fourth arc-shaped bearing surface opposite the third arc-shaped bearing surface, wherein, with respect to the shaving plane (SP), the third arc-shaped bearing surface has a convex shape and wherein the fourth arc-shaped bearing surface has a concave shape.

8. The razor head according to claim 4, wherein the pair of first walls comprise a first arc-shaped bearing surface that is oriented substantially in the vertical direction (z), respectively

9. The razor head according to claim 8, wherein the pair of first walls each comprise a stopper wall that extends from the first arc-shaped bearing surface at a position proximate the geometric center of the razor head towards the trailing edge and the back side.

10. The razor head according to claim 4, wherein the coupling section comprises two protrusions extending from the back side in the vertical direction (z), wherein the two protrusions are separated and/or aligned to each other with respect to the perpendicular direction (y), more specifically wherein the pair of first walls are arranged adjacent and between the two protrusions, respectively.

11. The razor head according to claim 10, wherein each of the protrusions comprises a second wall extending proximal an end of the respective protrusion in the perpendicular direction (y) towards a geometric center of the razor head, wherein the second wall defines a second arc-shaped bearing surface.

12. The razor head according to claim 4, wherein the pair of first walls each comprise a first length (l1) and wherein the pair of second walls each comprise a second length (l2) measured parallel to the perpendicular direction (y), wherein the first length (l1) is larger than the second length (l2).

13. The razor head according to claim 12, wherein the pair of first walls each comprise a first wall portion having the first length (l1) and a second wall portion having a third length (l3), more specifically wherein the first length (l1) is larger than the third length (l3).

14. The razor head according to claim 4, wherein the frame further comprises a leading longitudinal member defining a leading and a trailing longitudinal member defining a trailing edge, wherein a shaving plane (SP) is defined on the skin-contacting side of the frame,
more specifically wherein each bearing cavity comprises a bottom wall extending from a position proximate the leading edge towards the geometric center of the razor head under an angle, measured between the bottom wall and the shaving plane (SP), and wherein the bottom wall extends in the perpendicular direction (y) towards the geometric center of the razor head.

15. The razor head according to claim 14, wherein the trailing longitudinal member comprises a trimming assembly provided on the trailing edge.

16. The razor head according to claim 1, wherein the coupling section comprises a camming section.

17. The razor head according to claim 1, further comprising a connecting adapter, wherein the coupling section is releasably coupled to the connecting adapter via a pivotable or non-pivotable coupling, more specifically via the first and/or the second bearing mechanisms.

18. The razor head according to claim 17, wherein the connecting adapter comprises a body portion having a first connecting portion arranged at a first end of the connecting body.

19. The razor head according to claim 18, wherein the first connecting portion comprises a pair of bearing pins configured to be inserted into the pair of bearing cavities.

20. A kit of parts, comprising:
a razor cartridge holder comprising a plurality of razor heads according to claim 1, and
a razor handle.

21. (canceled)

22. (canceled)
